(19) United States
(12) Patent Application Publication
(10) Pub. No.: US 2014/0058925 A1
(43) Pub. Date: Feb. 27, 2014

(54) APPARATUS, METHOD AND ARTICLE TO AUTOMATE AND MANAGE FORMULA OR ASSET-BASED LENDING IN A NETWORKED ENVIRONMENT

(71) Applicant: Booyami, Inc., Fall City, WA (US)

(72) Inventors: James T. Walter, Fall City, WA (US); Peter D. Rosser, Kirkland, WA (US); Joseph Jude Donahue, Woodinville, WA (US); Robert N. Pulliam, Seattle, WA (US)

(73) Assignee: Booyami, Inc., Fall City, WA (US)

(21) Appl. No.: 13/972,622

(22) Filed: Aug. 21, 2013

Related U.S. Application Data
(60) Provisional application No. 61/691,696, filed on Aug. 21, 2012.

(51) Int. Cl. G06Q 40/02

(52) U.S. Cl. CPC G06Q 40/025
USPC 705/38

(57) ABSTRACT

Systems and methods automate and manage electronic exchange in the asset-based lending industry, particularly between borrowers and lenders. Such include automated extraction or import of relevant data, normalization of same; application of various rules and parameters as part of intermediate calculations, and provision of results to the lender, and optionally the borrower. The borrower may review and modify data. Various checks are implemented to ensure data is accurate and lender-specified rules are consistently applied. Rules may be customized per lender, per borrower, per customer, per asset type, and even per asset.

### BACKGROUND

1. Technical Field

The present disclosure generally relates to networked systems and methods, and in particular to systems and methods for facilitating formula or asset-based lending by lenders to borrowers or potential borrowers, based on an electronic exchange of digital information and automated evaluation.

2. Description of the Related Art

The lending industry typically includes a variety of entities which ensure that adequate financial resources are available to other entities for projects such as operating a business. Entities are typically grouped into two principal types based on their respective roles: 1) lenders and 2) borrowers or potential borrowers (collectively referred to herein as borrowers). Each of these entities may be of various sizes, for example individuals, small businesses (e.g., one to one hundred employees), large businesses (e.g., hundreds, thousands or even hundreds of thousands of employees), governments, governmental or quasi-governmental entities.

The lenders lend money or credit to the borrowers, typically in return for payment of interest and/or fees. The lenders are typically financial institutions with substantial financial resources. Lenders may take a variety of forms, for example deposit-taking institutions such as commercial banks, credit unions, trust companies, or for example institutions such as insurance companies, pension funds, investment banks, brokers or underwriters. Borrowers likewise can take a variety of forms, from individuals to businesses to governments. Business can range from small sole proprietorships to large multinational corporations.

Many businesses of all sizes wish to borrow capital, and lenders are typically willing to lend capital based on assets the borrowers possess. The capital may be useful for a variety of purposes, for example to more quickly fund acquisition of materials and labor necessary to produce future finished products. As an example, a business with $1,000,000 in accounts receivable may wish to borrow against this asset before collecting the amount due in order to accelerate the funding of new products or projects.

In order for businesses to be able to borrow against assets, a lender needs to be able to quantify the value of the assets, also known as the borrowing base, sometimes referred to as lending base. The lender may also need to or verify compliance with the loan conditions, which typically includes confirming the value of the assets from time to time while a loan or line of credit is in place, as well as reviewing the balance sheet and profit and loss statements for the borrower.

Asset data used for formula or asset-based lending typically includes data about accounts receivable, inventory, or other fixed assets. The amount and value of these assets are commonly stored or maintained in asset management systems, for instance accounting packages and/or Enterprise Resource Planning (ERP) systems. Accounting packages typically store accounts receivable (e.g., amounts invoiced and owing to the borrower) information, and may track inventory held by or in possession of the borrower. ERP systems typically track inventory held by or in possession of the borrower, and may track accounts receivable. Many commercially available or proprietary systems provide accounting package and enterprise resource planning capabilities.

Currently asset-based lending levels are determined through a multi-step, largely manual process. For example, physical inventory counts must be taken. Also for example, raw asset data is manually transcribed from an asset management system. Typically, asset valuation must be performed, assigning values to various assets. Further, intermediate calculations are manually applied to raw asset data to determine individual asset eligibility for borrowing base. The intermediate calculations are manually entered into a lender provided calculation system to determine total eligible amounts for the borrowing base. Intermediate calculations, for example, may include excluding some or all of the amount of accounts receivable from a single customer if the amount surpasses a set limit (i.e., concentration percentage). This process may often involve additional acts, and the above discussion is not meant to be exhaustive, but rather provide a broad outline of common practices.

### BRIEF SUMMARY

Current approaches present a number of problems or drawbacks. For example, current approaches require a substantial amount of time to transcribe data out of existing accounting and ERP systems. Current approaches are plagued by the complexities and time required to perform various intermediate calculations. Current approaches also tend to fail to provide sufficient fidelity of intermediate calculations, which intermediate calculations may be supposed to be based on a lender's desired or specified parameters.

Under current approaches, borrowers expend substantial amounts of time copying accounting data and performing intermediate calculations. Lenders likewise expend substantial amounts of time auditing asset data, checking intermediate calculations, and performing total calculations. Further, intermediate calculations such as concentration percentage, cross-aging, credit memos, per-customer calculations, and contra accounts are often calculated inconsistently and differently than intended. Consequently, the final numbers are often inaccurate due to the manual nature of the process. Typically, verification is at most cursory, and is often not performed until and unless an issue arises such as a default, at which time checking is too late.

When inaccuracies reduce the borrowing base, borrowers are not sufficiently leveraging their assets. Lenders are likewise not realizing full use of their assets, often losing out on possible revenue from interest fees. When inaccuracies increase the borrowing base, lenders are exposed to higher unknown or unappreciated risk, lending on a smaller borrowing base than intended. In particular, the market has accounted for this in the aggregate, but not in the specific. In order to continue to make profits in the face of inaccuracies, lenders resort to pooling risk amongst many borrowers, reducing efficiency for any given borrower. The mechanism currently in use is an increase in interest rates and the reduction in advance rates (the percentage of a gross borrowing base that contributes to the credit limit). Increasing the fidelity of the formulas allows lenders to use more targeted rates and lending decisions.

More flexible approaches to electronic or digital communications in the formula or asset-based lending industry are desirable. Particularly desirable are approaches that accommodate the specific needs of various entities, while automating and managing certain aspects of the interaction between the entities. Lenders desire up-to-date or current and accurate tracking or reporting on assets of borrowers. Lenders also desire that their own specific loan parameters or rules be applied. Lenders typically make a large number of loans, some which are ongoing for years, for instance lines of credit. Lenders may apply different rules for different borrowers, for example based on business type, business size, or past experience with the particular borrower or similar borrowers. Borrowers need to comply with the lender's desires for reporting and tracking, but would like to reduce the often significant workload required to provide the reporting and tracking. Accurate reporting is important for both the lender and the borrower, allowing the full leveraging of the borrower's assets, which assures that the lender correctly gauges the risks involved in the loan or advance. Borrowers also need to control their own data or information, and to review data, information, and/or results to assure such accurately reflect their financial position.

Systems and methods automate and manage electronic communications in the formula or asset-based lending industry, particularly between borrowers and lenders. Such include a collaboration environment to automate the reporting and tracking of assets, and the analysis of the same.

Broadly, an asset data optimizer may include a system that extracts raw asset data from borrower asset management systems and normalizes the extracted raw data into a standard form, optimized to asset-based borrowing base determination.

Broadly, a contra account automator may include a system that matches customers and vendors to identify a single business entity which is both a customer and a vendor of a borrower, and which calculates an appropriate amount for accounts receivable to be counted as an eligible asset towards a borrowing base based at least in part on accounts payable to the business entity. Advantageously, the system may treat two or more business which are closely related as a single business entity for the purposes of contra accounts. For example, a customer A and a vender B may each be different subsidiaries of the same corporation, hence treated as contra accounts. Also for example, a customer C's brother owns a vendor D, and thus are treated as contra accounts to each other.

The systems and methods may treat two separate entities are a single or combined entity where a defined relationship between the separate entities exists. For example, a customer E and customer F may each be different departments of a governmental entity, and thus are treated as a single customer account. Thus, any entities judged by a lender's policies to be a single entity by virtue of their relationship may be treated as combined.

Broadly, an integrated calculator may include a system that calculates intermediate and total eligible amounts on a customer-by-customer, invoice-by-invoice basis, from standardized, asset-based-lending-optimized data.

A calculation viewer may include a system that displays intermediate and total eligible amounts of an asset-based borrowing base on a per-customer or per-asset basis, which amounts include intermediate totals of all eligibility and exclusions, and which may highlight or emphasize adjustments and per-customer exceptions.

A method of operation of a trusted third party evaluation system that includes at least one processor, at least one nontransitory processor-readable medium, and at least one communications port may be summarized as including receiving parameters input by the trusted third party evaluation system from at least a first lender computer system controlled by a first lender, the parameters input specifying a number of parameters imposed by at least the first lender; receiving respective borrower accounting information including data and metadata for each of a number of borrowers by the evaluation system from each of a number of accounting modules executed on a number of source computer systems which are distinct from the first lender computer system, the data and metadata representative of a number of accounts maintained by each borrower, the data and metadata representative of a plurality of invoices; and for each of a plurality of borrower accounts maintained by the first lender and logically associated with a respective one of the borrowers: for each of the plurality of accounts maintained by the respective one of the borrowers: for each of the plurality of invoices issued to or received from the respective one of the accounts: determining an age of the respective invoice based on a first piece of metadata and a reporting date, determining if the determined age of the respective invoice exceeds a defined age limit, adding a total amount of the respective invoice to an over aged invoice limit value if the determined age of the respective invoice exceeds the defined age limit, adding the amount of the respective invoice to a gross accounts receivable value, and for each of the plurality of invoices issued to the respective one of the accounts: determining an exclusion amount, and determining an eligible total accounts receivable value for the respective account based at least in part on the determined exclusion amount; and determining an eligible total accounts receivable value for the respective account based at least in part on the determined eligible total accounts receivable values of the plurality of accounts maintained by the respective borrower.

Receiving respective borrower accounting information may include importing the respective borrower accounting information directly from the accounting modules executed on the source computer systems. Receiving respective borrower accounting information may include importing the respective borrower accounting information directly from data files without communicating with the accounting modules executed on the source computer systems. Receiving respective borrower accounting information may include receiving respective normalized borrower accounting information for each of the borrower accounts from the source computer systems by the trusted third party evaluation system. Determining an exclusion amount may include determining whether the invoice was sent by the respective borrower or received by the respective borrower. At least one of the invoices may have a negative amount and may be a credit memorandum, and may further include subtracting the negative amount of the respective credit memorandum from the gross accounts receivable value. Determining an exclusion amount may include, for each of a number of defined exclusions types: determining whether at least one characteristic of the respective invoice meets one or more exclusion conditions of the respective exclusion type; and setting the exclusion amount equal to an accounts receivable amount of the respective invoice if all of the at least one characteristic of the respective invoice meets the one or more exclusion conditions. Determining an exclusion amount may include, for each of a number of exclusion criteria: determining whether an accounts receivable for the respective invoice meets one or more exclusion conditions of the respective exclusion type; and setting the exclusion amount equal to a lesser of: an accounts receivable amount of the respective invoice or a sum of contra account amounts, if all of the at least one characteristic of the respective invoice meets the one or more exclusion conditions. Determining an eligible total accounts receivable value for the respective borrower account may include subtracting a number of lender exclusion amounts from an accounts receivable amount. Determining an eligible total accounts receivable value for the respective borrower account may include multiplying an accounts receivable amount by a defined advance rate for the first lender. Determining an eligible total accounts receivable value for the respective borrower account may include limiting the eligible total to a maximum accounts receivable amount specified by the first lender. Determining an eligible total accounts receivable value for the respective borrower account may include multiplying an accounts receivable amount by a defined advance rate for the first lender. Determining an eligible total accounts receivable value for the respective borrower account may include limiting the eligible total to a maximum accounts receivable amount specified by the first lender.

An evaluation system may be summarized as including at least one nontransitory processor-readable medium that stores at least one of information or processor executable instructions; at least one communications port; and at least one processor communicatively coupled to the at least one nontransitory processor-readable medium and to the at least one communications port, and which: receives parameters input via the at least one communications port from at least a first lender computer system controlled by a first lender, the parameters input specifying a number of parameters imposed by at least the first lender; receives respective borrower accounting information including data and metadata for each of a number of borrowers via the at least one communications port from each of a number of accounting modules executed on a number of source computer systems which are distinct from the first lender computer system, the data and metadata representative of a plurality of invoices; and for each of a plurality of borrower accounts maintained by the first lender and logically associated with a respective one of the borrowers: for each of the plurality of accounts maintained by the respective one of the borrowers: for each of the plurality of invoices issued to or received from the respective one of the accounts: determines an age of the respective invoice based on a first piece of metadata and a reporting date, determines if the determined age of the respective invoice exceeds a defined age limit, adds a total amount of the respective invoice to an over aged invoice limit value if the determined age of the respective invoice exceeds the defined age limit, adds the amount of the respective invoice to a gross accounts receivable value, subtracting the amount of the respective credit memorandum from a gross accounts receivable value; and for each of the plurality of customer accounts maintained by the respective one of the borrowers: for each of the plurality of invoices for the accounts: determines an exclusion amount, and determines an eligible total accounts receivable value for the respective borrower account based at least in part on the determined exclusion amount.

The respective borrower accounting information received via the at least one communications port may be normalized borrower accounting information for each of the borrower accounts from the source computer systems. To determine an exclusion amount the at least one processor may determine whether the invoice was sent by the respective borrower or received by the respective borrower. At least one of the invoices may have a negative amount and may be a credit memorandum, and the at least one processor may further subtract the negative amount of the respective credit memorandum from the gross accounts receivable value. To determine an exclusion amount the at least one processor, for each of a number of defined exclusions types: may determine whether at least one characteristic of the respective invoice meets one or more exclusion conditions of the respective exclusion type; and may set the exclusion amount equal to an accounts receivable amount of the respective invoice if all of the at least one characteristic of the respective invoice meets the one or more exclusion conditions. To determine an exclusion amount the at least one processor, for each of a number of exclusion criteria: may determine whether an accounts receivable for the respective invoice meets one or more exclusion conditions of the respective exclusion type; and may set the exclusion amount equal to a lesser of: an accounts receivable amount of the respective invoice or a sum of contra account amounts, if all of the at least one characteristic of the respective invoice meets the one or more exclusion conditions. To determine an eligible total accounts receivable value for the respective borrower account the at least one processor may subtract a number of lender exclusion amounts from an accounts receivable amount. To determine an eligible total accounts receivable value for the respective borrower account the at least one processor may further multiply an accounts receivable amount by a defined advance rate for the first lender. To determine an eligible total accounts receivable value for the respective borrower account the at least one processor may further limit the eligible total to a maximum accounts receivable amount specified by the first lender.

A method of operation of a system that includes at least one processor, at least one nontransitory processor-readable medium, and at least one communications port may be summarized as including extracting accounts receivable information by the at least one processor from at least one accounting module for all of a plurality of outstanding invoices originated by a borrower including data and metadata, the data and metadata representative of respective sets of customer identity information, a respective invoice date and a respective invoice amount for each of the plurality of outstanding invoices originated by the borrower; extracting accounts payable information by the at least one processor from at least one accounting module for all of a plurality of outstanding invoices received by the borrower including data and metadata, the data and metadata representative of respective sets of vendor identity information, a respective invoice date and a respective invoice amount for each of the plurality of outstanding invoices received by the borrower; and transferring the extracted information to a trusted third party computer system via that at least one communications port.

Extracting accounts receivable information may include extracting the customer identity information in the form of a customer name, a customer address, a customer telephone number, a customer facsimile number or a customer uniform resource locator (URL). Extracting accounts payable information may include extracting the vendor identity information in the form of a vendor name, a vendor address, a vendor telephone number, a vendor facsimile number, or a vendor uniform resource locator (URL). The method may further include extracting accounts receivable information by the at least one processor from at least one accounting module for all of a plurality of outstanding credit memorandums originated by the borrower including data and metadata, the data and metadata representative of respective sets of customer identity information, a respective credit memorandum date and a respective credit memorandum amount for each of the plurality of outstanding credit memorandums originated by the borrower.

The method may further include unifying at least one of a number of customer entities or a number of vendor entities; matching accounts receivable over a number of the outstanding invoices originated by the borrower to a number of the customer entities; and matching accounts payable over a number of the outstanding invoices received by the borrower to a number of the vendor entities. Extracting a set of accounting information may include directly importing the set of accounting information. Extracting a set of accounting information may include extracting the set of accounting information via a number of application programming interface calls to the at least one accounting module.

An evaluation system may be summarized as including at least one nontransitory processor-readable medium that stores at least one of information or processor executable instructions; at least one communications port; and at least one processor communicatively coupled to the at least one nontransitory processor-readable medium and to the at least one communications port, and which: extracts accounts receivable information from at least one accounting module for all of a plurality of outstanding invoices originated by a borrower including data and metadata, the data and metadata representative of respective sets of customer identity information, a respective invoice date and a respective invoice amount for each of the plurality of outstanding invoices originated by the borrower; extracts accounts payable information from at least one accounting module for all of a plurality of outstanding invoices received by the borrower including data and metadata, the data and metadata representative of respective sets of vendor identity information, a respective invoice date and a respective invoice amount for each of the plurality of outstanding invoices received by the borrower; and transferring the extracted information to a trusted third party computer system via the at least one communications port.

To extract accounts receivable information the at least one processor may extract the customer identity information in the form of a customer name, a customer address, a customer telephone number, and a customer facsimile number. To extract accounts payable information the at least one processor may extract the vendor identity information in the form of a vendor name, a vendor address, a vendor telephone number, and a vendor facsimile number. The at least one processor may further extract accounts receivable information from at least one accounting module for all of a plurality of outstanding credit memorandums originated by the borrower including data and metadata, the data and metadata representative of respective sets of customer identity information, a respective credit memorandum date and a respective credit memorandum amount for each of the plurality of outstanding credit memorandums originated by the borrower.

The at least one processor may further: unify at least one of a number of customer entities or a number of vendor entities; match accounts receivable over a number of the outstanding invoices originated by the borrower to a number of the customer entities; and match accounts payable over a number of the outstanding invoices received by the borrower to a number of the vendor entities. To extract the set of accounting information the at least one processor may directly import the set of accounting information. To extract the set of accounting information the at least one processor may extract the set of accounting information via a number of application programming interface calls to the at least one accounting module.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a networked asset-based lending industry environment according to one illustrated embodiment, including an asset lending management system; a plurality of borrowers each with associated devices to provide communications with the asset lending management system; and a plurality of lenders each with associated devices to provide communications with the asset lending management system.

FIG. 2 is a functional block diagram of an asset lending management system networked to a borrower operated processor-based device and a lender operated processor-based device, according to one illustrated embodiment.

FIG. 3 is a flow diagram showing a high level method of operation of an asset-based lending management system to automate and/or manage asset-based lending between lenders and borrowers, according to one illustrated embodiment.

FIG. 4 is a schematic diagram showing an asynchronous sequence in a transaction pipeline for use in operation of an asset-based lending management system, according to one illustrated embodiment.

FIG. 5 is a flow diagram showing a method of enqueueing a transaction in operation of an asset-based lending management system, according to one illustrated embodiment.

FIG. 6 is a flow diagram showing a method of processing transactions in operation of an asset-based lending management system, according to one illustrated embodiment.

FIG. 7 is a flow diagram showing a method of normalizing data in operation of an asset-based lending management system, according to one illustrated embodiment.

FIG. 8 is a flow diagram showing a method of transforming data in operation of an asset-based lending management system, according to one illustrated embodiment.

FIG. 9 is a flow diagram showing calculating a transaction in operation of an asset-based lending management system, according to one illustrated embodiment.

FIG. 10 is a flow diagram showing a method of detecting contras in operation of an asset-based lending management system, according to one illustrated embodiment.

FIG. 11 is a flow diagram showing a method of detecting foreign-based assets in operation of an asset-based lending management system, according to one illustrated embodiment.

FIG. 12 is a flow diagram showing a method of calculating totals in operation of an asset-based lending management system, according to one illustrated embodiment.

FIG. 13 is a flow diagram showing a method of calculating accounts receivable in operation of an asset-based lending management system, according to one illustrated embodiment.

FIG. 14 is a flow diagram showing a method of aging invoices in operation of an asset-based lending management system, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, server computers, and/or communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The term “borrower” as well as related terms such as “borrowers” and “potential borrower” are used interchangeably herein, to refer to an entity that interacts with a lender in order to at least attempt to obtain or maintain a loan or advancement of funds or capital which is secured or backed by assets of the entity.

The term “lender” as well as related terms such as “lenders” is used herein to refer to an entity that loans or advances or potentially loans or advances funds or capital to borrowers which loan or advance is secured or backed by assets of borrower(s).

The term “customer” as well as related terms such as “customers” is used herein to refer to an entity that buys goods and/or services from borrower(s).

The headings and Abstract of the Disclosure provided herein are for convenience only and do not interpret the scope or meaning of the embodiments.

This disclosure describes various systems, methods and articles related to electronic commerce and in particular electronic commerce related to asset-based lending. While specific structures and acts associated with particular illustrated embodiments are disclosed, other structures and acts may be employed in other embodiments.

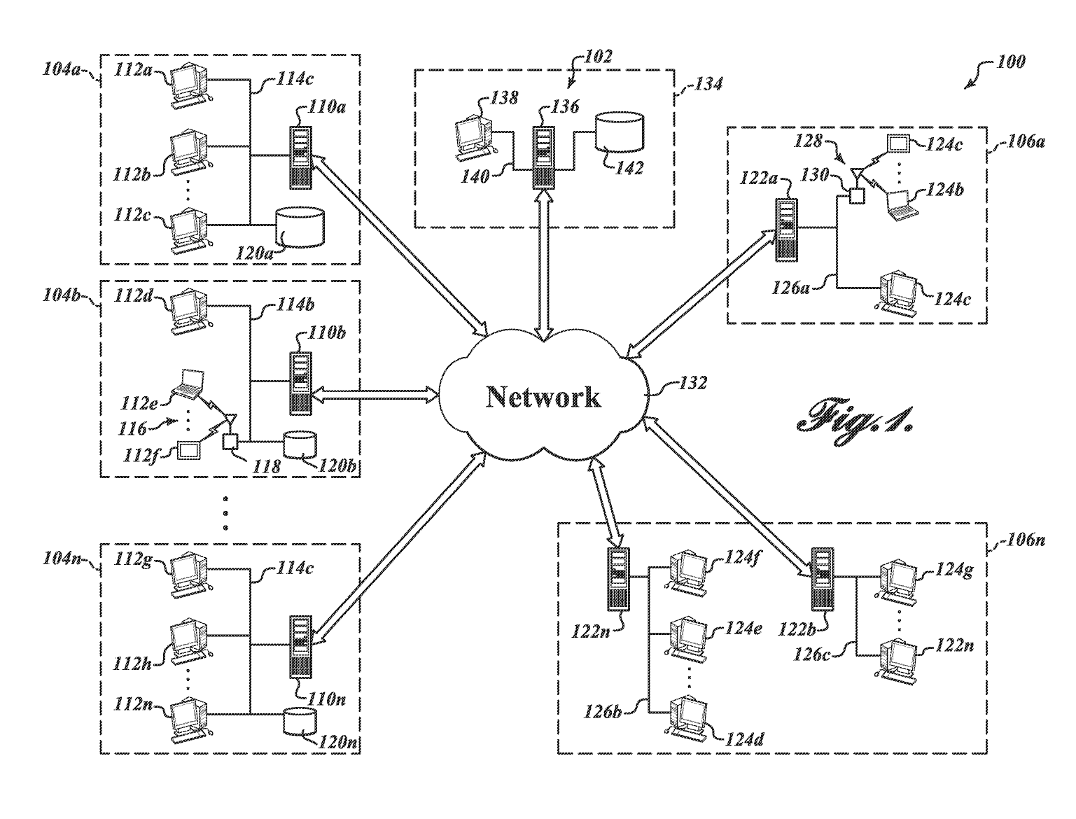

FIG. 1 shows a networked asset-based lending industry environment 100, according to one illustrated embodiment.

The networked asset-based lending industry environment 100 includes an asset-based lending management system 102, a plurality of borrowers 104a, 104b-104n (three shown, collectively 104), and a plurality of lenders 106a-106n (two shown, collectively 106).

The borrowers 104 may take any variety of forms, for example, being of any of a variety of sizes. For example, borrowers 104 may be individuals such as individuals operating as a sole proprietorship. Borrowers 104 may be small businesses such as small corporations, partnerships, limited partnerships, limited liability companies or other companies or businesses. Borrowers 104 may be large businesses such as large corporations or even large multi-national corporations.

Each borrower 104 may have one or more server computers 110a, 110b-110n (only one per borrower 104 shown, collectively 110) to provide electronic communications externally from and/or internally within the borrower 104. Borrowers 104 may often have more than one server computer system 110, particularly where the size of the borrower 104 or the amount of business handled by the borrower 104 justifies a larger number of server computer systems 110. Each borrower 104 may have a number of processor-based devices 112a, 112b, 112c, 112d, 112e, 112f, 112g, 112h-112n (three shown per agency 104, collectively 112). The processor-based devices 112 may take a variety of forms which allow input and output by an end user. For example, the processor-based devices may take the form of personal computers 112a-112d, 112g-112n, laptop or notebook computers 112e, or tablet computers 112f. The processor-based devices 112 may be communicatively coupled to the respective server computers 110 via one or more networks, for example, one or more wired (e.g., electrical conductors, optical fibers) networks 114a, 114b-114n (only one per borrower 104 shown, collectively 114) and/or wireless networks 116 (only one shown) via one or more wireless access points 118 (only one shown). One or more of the computers 110 and/or the processor-based devices 112 may take the form of an accounting system or ERP system, and/or may execute accounting software or ERP software to track and maintain information about assets such as accounts receivable, accounts payable, inventory, parts, or other fixed assets. Each borrower 104 may have at least one nontransitory computer- or processor-readable storage medium 120a, 120b-120n (collectively 120). The nontransitory computer- or processor-readable storage medium 120 stores a variety of information including asset-related information such as information about accounts receivable, inventory, fixed assets, accounts payable, etc.

The lenders 106 may take any variety of forms, typically constituting relatively large financial institutions such as commercial or investment banks, credit unions, trust companies, insurance companies, etc.

Each lender 106 may have one or more server computers 122a, 122b-122n (three shown, collectively 122) to provide electronic communications either externally from and/or internally within the lender 106. Given the size of most lenders 106, lenders 106 will typically have more than one server computer system 122. Each lender 106 may have a number of processor-based devices 124a, 124b, 124c, 124d, 124e, 124f, 124g-124n (eight shown, collectively 124). The processor-based devices 124 may take a variety of forms which allow input and output by an end user (e.g., underwriter 108). For example, the processor-based devices may take the form of personal computers 124a, 124d-124n, laptop or notebook computers 124b, or tablet computers 124c. The processor-based devices 124 may, for example, be communicatively coupled to the respective server computers 110 via one or more networks, for example one or more wired networks 114a, 114b-114n (only one per lender 106 shown, collectively 114) and/or wireless networks 128 (only one shown) via one or more wireless access points 130 (only one shown).

The borrowers 104 will typically have a need for funds or capital, for instance to allow production and/or distribution of goods or provision of services, prior to receipt of payment from the borrower's customers, distributors, or retailers. The borrowers 104 typically have assets, for example accounts receivable owed by customers, distributors, retailers, or inventory and/or other fixed assets (e.g., machinery, equipment, furnishings, parts). In many instances, borrowers 104 are willing to commit these assets as collateral to back a loan from a lender 106.

Each lender 106 may evaluate borrowers, and selectively decide to provide funds or capital to a borrower 104 on certain terms. The terms typically provide for payment of interest by the borrower 104 to the lender for the term of the loan or advance. The terms also typically provide for securing of the loan or advance via collateral in the form of the borrower's assets. Hence, the terms typically further provide reporting parameters which require the borrower 104 to report on the status of assets. These reports are typically scheduled periodically, for example daily, weekly, monthly, or quarterly, but may also be aperiodic (e.g., on demand).

The asset-based lending management system 102 operates as an intermediary between the processor-based devices 112 of the borrowers 104 and the processor-based devices 124 of the lenders 106, to facilitate the reporting or monitoring of assets. The processor-based devices 112 of the borrowers 104 and the processor-based devices 124 of the lenders 106 electronically communicate over one or more networks, for example, over a wide area network 132 such as the Internet or an extranet. The asset-based lending management system 102 may be operated by an entity 134 that is separate, and independent from the borrowers 104 and lenders 106, and hence constitutes a trusted third party with respect to the borrowers 104 and lenders 106.

The asset-based lending management system 102 may have one or more server computers 136 (only one illustrated) to provide electronic communications either externally from and/or internally within the entity 134. To handle the load of multiple borrowers 104 and multiple lenders 106, the asset-based lending management system 102 will typically have more than one server computer system 136. The asset-based lending management system 102 may include one or more terminals or personal computers 138 (only one shown), communicatively coupled to the server computer 136 via one or more wired or wireless networks 140 (only one shown). The terminals or personal computers 138 allow input and output by an end user (e.g., employee or contractor of the entity 134).

The asset-based lending management system 102 includes at least one nontransitory computer- or processor-readable storage medium 142. The nontransitory computer- or processor-readable storage medium 142 stores a variety of information about the borrowers 104, lenders 106 and/or assets, facilitating the automation and management of communications therebetween, including the transmission of electronic correspondence including electronic messages and/or electronic or digital documents or data.

At times it may be necessary or desirable to share some or all of the electronic or digital documents or files or data between one or more of the entities (e.g., borrowers 104, lenders 106, and/or optionally the borrower's customers, distributors, retailers or vendors (not shown)). Sharing the electronic or digital documents or files or data may include allowing interactions with such files, for example, viewing, modifying, copying, annotating, importing, exporting, and/or deleting. Additionally, or alternatively, it may be desirable to change ownership for one or more of the electronic or digital documents or files. The terms electronic and digital are used interchangeably herein and in the claims. For example, such terms are used to modify the noun “document” or “data” to indicate a set of data that is in a format suitable for use by a processor-based device, for storage in computer- or processor-readable form, or for transmission via a communications network. As used herein and in the claims, the term “document” includes single page or multiple page documents, or any other set of data whether in the form of a text or alphanumeric based binary file (e.g., ASCII, or .doc, .docx, .xlb, xls, csv file extensions), in the form of an image (e.g., binary image, vector based image, Portable Data File or PDF®) of a text, alphanumeric or graphic based document, or in the form of a markup language based file (e.g., HTML, XML).

In most implementations, the most up-to-date or current asset-related information (e.g., accounts receivable, inventory, fixed assets) will be stored by the server computers 110 or processor-based devices 112 of the respective borrower 104, or stored on computers or databases of an agent of the borrower 104 such as an accounting firm and/or a firm providing ERP services. The asset-based lending management system 102 may retrieve, import or extract the asset-related information from the server computers 110, processor-based devices 112, or the nontransitory computer- or processor-readable storage media 120 of the respective borrowers 104 or their agents. The asset-based information may be retrieved periodically (e.g., daily, weekly, monthly, quarterly) or on demand.

However, in some implementations, the nontransitory computer- or processor-readable storage medium 142 may constitute a common electronic document repository to store electronic or digital documents or files or data. As used herein and in the claims, the term “common electronic document repository” means electronic or digital document or file storage media which is shared by two or more networked nodes, such as two or more servers 110, 122 associated with borrowers 104 and/or lenders 106, and hence is common to at least two network nodes. The common electronic document repository may be implemented in one or across more than one computer- or processor-readable storage media (e.g., write once, read many). The common electronic document repository may include one or more databases which state information or data regarding the electronic or digital documents or files. Such database(s) may be stored separately from the electronic or digital documents, for example, on storage medium that may be rewritten many times (e.g., hard drive, RAID, RAM). The common electronic document repository may be co-located with the asset-based lending management system 102, for example in the same room, building or facility. Alternatively, the common electronic document repository may be located remotely from the asset-based lending management system 102, for example in a different facility, city, state or country. Electronic or digital documents or files are collections of information stored at specific locations in non-transitory computer- or processor-readable media, thus are logically addressable portions of such media, which may or may not be contiguous.

While FIG. 1 illustrates a representative networked asset-based lending industry environment, typical networked asset-based lending industry environments may include many additional computer systems and entities. The concepts taught herein may be employed in a similar fashion with more populated networked asset-based lending industry environments.

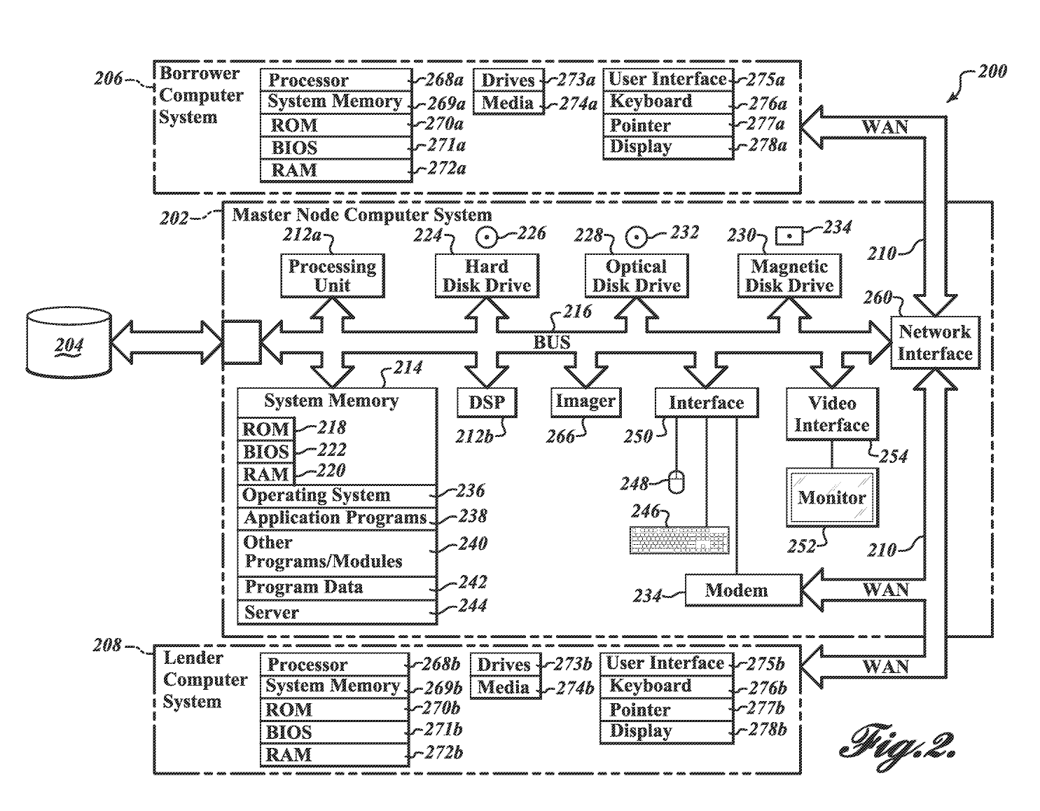

FIG. 2 and the following discussion provide a brief, general description of a suitable networked asset-based lending industry environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices, multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 2 shows a networked asset-based lending industry environment 200 comprising one or more asset-based lending management computer systems 202 (only one illustrated) and one or more associated nontransitory computer- or processor-readable storage medium 204 (only one illustrated). The associated nontransitory computer- or processor-readable storage medium 204 is communicatively coupled to the asset-based lending management computer system(s) 202 via one or more communications channels, for example, one or more parallel cables, serial cables, or wireless channels capable of high speed communications, for instance, via FireWire®.

The networked asset-based lending industry environment 200 also comprises one or more borrower associated computer systems 206 (only one illustrated) and one or more lender associated computer systems 208 (only one illustrated). The borrower associated computer systems 206 and the lender associated computer systems 208 are communicatively coupled to the asset-based lending management computer system(s) 202 by one or more communications channels, for example, one or more wide area networks (WANs) 210.

In operation, the borrower associated computer systems 206 typically function as either a server to other end user computer systems (i.e., clients) associated with a respective entity (e.g., borrower) or as end user computer systems (i.e., clients) themselves, for example, executing accounting and/or ERP software. In operation, the asset-based lending management computer system(s) 202 typically functions to extract or retrieve raw asset information of a borrower, process the raw asset information, and act as a server with respect to the lender associated computer systems 208 to provide lenders with access to processed, and optionally raw, asset information of a borrower. The asset-based lending management computer system(s) 202 may, for example, extract or retrieve raw asset information of a borrower from an accounting and/or ERP system, or from some other store of information. In operation, the lender associated computer systems 208 typically function as either a server to other end user computer systems (i.e., clients) associated with a respective entity (e.g., lender) or as end user computer systems (i.e., clients) themselves, for example, executing a browser to provide a lender with access to processed, and optionally raw, asset information of a borrower via the asset-based lending management computer system(s) 202.

The networked asset-based lending industry environment 200 may employ other computer systems and network equipment, for example, additional servers, proxy servers, firewalls, routers and/or bridges. The asset-based lending management computer system(s) 202 will at times be referred to in the singular herein, but this is not intended to limit the embodiments to a single device since in typical embodiments there may be more than one asset-based lending management computer system(s) 202 involved. Unless described otherwise, the construction and operation of the various blocks shown in FIG. 2 are of conventional design. As a result, such blocks need not be described in further detail herein, as they will be understood by those skilled in the relevant art.

The asset-based lending management system server computer system(s) 202 may include one or more processing units 212a, 212b (collectively 212), a system memory 214 and a system bus 216 that couples various system components, including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and/or a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the asset-based lending management system server computer 202, such as during start-up.

The asset-based lending management computer system(s) 202 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer-readable instructions, data structures, program modules and other data for the asset-based lending management system server computer 202. Although the depicted asset-based lending management computer system(s) 202 is illustrated employing a hard disk 224, optical disk 228 and magnetic disk 230, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to automatically extract, import from or retrieve asset-related information from borrowers and store such to the associated nontransitory computer- or processor-readable storage medium 204. Application programs 238 may include instructions that cause the processor(s) 212 to automatically process the extracted, imported or otherwise retrieved asset-related information. The asset-related information may, for example, be retrieved via communications with one or more accounting modules for instance via a set of API calls, or by directly accessing stored information without communicating via the accounting modules, or via a trusted third party system. The asset-related information may, for example, be processed according to lender-specified criteria.

Application programs 238 may include instructions that cause the processor(s) 212 to automatically control access to certain information based on certain criteria. For example, the instructions may limit other borrowers or lenders from seeing information about a specific borrower, unless the specific borrower has previously identified the other entity to receive access to the access-related information. Application programs 238 may include instructions that cause the processor(s) 212 to automatically send, transmit, transfer, or otherwise provide electronic communications from a borrower to a lender, or from a lender to a borrower. Such may include sending, transmitting, transferring or otherwise providing access to electronic or digital documents or files or data to the lender(s) defined or identified by the particular borrower. Such may allow asset-related information to be seamlessly automatically distributed via electronic communications and documents.

Application programs 238 may include instructions that cause the processor(s) 212 to automatically establish, maintain, update or record relationship or affiliation information. Such may include logical relationships between borrowers and their agents or affiliates and/or lenders and their agents or affiliates. Such may include updating records in a database or table. Application programs 238 may include instructions that cause the processor(s) 212 to automatically establish, maintain, update or record ownership information with respect to electronic or digital documents or files or data, as well as privileges, permissions or authorizations to perform various acts on such electronic or digital documents or files such as reading, modifying, annotating, extracting, importing, retrieving, and/or deleting. Application programs 238 may even further include instructions to create entries in and/or query one or more databases which store information or data about borrowers, their customers, their vendors, and/or the electronic or digital documents or files or data, regardless of location at which those electronic or digital documents or data are stored.

Other program modules 240 may include instructions for handling security such as password or other access protection and communications encryption.

The system memory 214 may also include communications programs, for example, a server 244 that causes the asset-based lending management system server computer 202 to serve electronic or digital documents or files via corporate intranets, extranets, or other networks as described below. The server 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable severs may be commercially available such as those from Mozilla, Google, Microsoft and Apple Computer.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the asset-based lending management system server computer(s) 202 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The asset-based lending management computer system(s) 202 can include other output devices, such as speakers, printers, etc.

The asset-based lending management computer system(s) 202 can operate in a networked environment using logical connections to one or more remote computers and/or devices. For example, the asset-based lending management computer system(s) 202 can operate in a networked environment using logical connections to one or more borrower associated computer systems 206 and lender associated computer systems 208. Communications may be via a wired and/or wireless network architecture, for instance, wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the asset-based lending management computer system(s) 202, the borrower associated computer systems 206 and the lender associated computer systems 208.

The borrower associated computer systems 206 and the lender associated computer systems 208 will typically take the form of end user processor-based devices, for instance, mainframe computers, workstation computers, personal computers (e.g., desktop or laptop computers), net book computers, even tablet computers and/or smart phones and the like, executing appropriate instructions. These end user processor-based devices may be communicatively coupled to one or more server computers. For instance, borrower devices may be communicatively coupled externally from the respective borrower via one or more borrower server computers, which may implement a firewall. For instance, lender devices may be communicatively coupled externally from the respective lender via one or more lender server computers, which may implement a firewall. The server computers may execute a set of server instructions to function as a server for a number of end user computer systems (i.e., clients) communicatively coupled via a LAN at a facility or site. The end user computer systems 206, 208 may execute a set of client instructions to function as a client of the server computer(s), which are communicatively coupled via a WAN.

The borrower associated computer systems 206 and the lender associated computer systems 208 may include one or more processing units 268a, 268b (collectively 268), system memories 269a, 269b (collectively 269) and a system bus (not shown) that couples various system components including the system memory 269 to the processing unit 268. The borrower associated computer systems 206 and the lender associated computer systems 208 will at times each be referred to in the singular herein, but this is not intended to limit the embodiments to a single borrower associated computer system 206 and/or the lender associated computer systems 208. In typical embodiments, there may be more than one borrower associated computer systems 206 and there will likely be a large number of lender associated computer systems 208.

The processing unit 268 may be any logic processing unit, such as one or more central processing units (CPUs), digital signal processors (DSPs), application-specific integrated circuits (ASICs), field programmable gate arrays (FPGAs), etc. Non-limiting examples of commercially available computer systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Unless described otherwise, the construction and operation of the various blocks of the satellite node server computer systems 206 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270a, 270b (collectively 270) and random access memory (“RAM”) 272a, 272b (collectively 272). A basic input/output system (“BIOS”) 271a, 271b (collectively 271), which can form part of the ROM 270, contains basic routines that help transfer information between elements within the end user computer systems 206, 208, such as during start-up.

The borrower associated computer systems 206 and the lender associated computer systems 208 may also include one or more media drives 273a, 273b (collectively 273), e.g., a hard disk drive, magnetic disk drive, WORM drive, and/or optical disk drive, for reading from and writing to computer-readable storage media 274a, 274b (collectively 274), e.g., hard disk, optical disks, and/or magnetic disks. The computer-readable storage media 274 may, for example, take the form of removable media. For example, hard disks may take the form of a Winchester drive, and optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program modules and other data for the borrower associated computer systems 206 and/or the lender associated computer systems 208. Although described as employing computer-readable storage media 274 such as hard disks, optical disks and magnetic disks, those skilled in the relevant art will appreciate that end user computer systems 206, 208 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, electronic or digital documents or files or data (e.g., metadata, ownership, authorizations) related to such can be stored in the computer-readable storage media 274.

Program modules, such as an operating system, one or more application programs, other programs or modules and program data, can be stored in the system memory 269. Program modules may include instructions for accessing a Website, extranet site or other site or services (e.g., Web services) and associated WebPages, other pages, screens or services hosted by the asset-based lending management system 102. Program modules may include instructions for storing certain or selected electronic correspondence and/or electronic or digital documents or files or changes thereto to nontransitory computer- or processor-readable storage medium, such as local media 274a, 274b, or remote media (not shown). Alternatively, the instructions may cause retrieval of electronic correspondence and/or electronic or digital documents or files or changes to existing electronic correspondence and/or electronic or digital documents or files. Program modules may additionally include instructions for handling security such as ownership, password or other access protection and communications encryption. In the case of a borrower end user computer systems 206, one or more program modules may include instructions that implement an accounting system or package to track accounts receivable and accounts payable. Additionally or alternatively, in the case of a borrower end user computer systems 206, one or more program modules may include instructions that implement ERP system or package to track inventory.

In particular, the system memory 269 may include communications programs that permit the borrower associated computer systems 206 and the lender associated computer systems 208 exchange electronic correspondence and/or electronic or digital documents or files or data with the associated nontransitory computer- or processor-readable storage medium 204. The system memory 269 may additionally include communications programs that permit the asset-based lending management computer system(s) 202 to extract, import from or retrieve asset-related electronic correspondence and/or electronic or digital documents or files from the borrower associated computer systems 206. The retrieval may be directly, or may be via application programming interface (API) calls. Such may require that the asset-based lending management computer system(s) 202 have sufficient right, permission, privilege or authority for such an action. The system memory 269 may also include other communications programs, for example, a Web client or browser that permits the borrower associated computer systems 206 and particularly the lender associated computer systems 208 to access and exchange data with sources such as Web sites of the Internet, corporate intranets, extranets, or other networks. Such may require that the lender associated computer systems 208 have sufficient right, permission, privilege or authority for accessing a given borrower's asset-related information via the asset-based lending management computer system(s) 202. The browser may, for example, be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/modules, program data and/or browser can be stored on the computer-readable storage media 274 of the media drive(s) 273. An operator can enter commands and information into the borrower associated computer systems 206 and the lender associated computer systems 208 via a user interface 275a, 275b (collectively 275) through input devices such as a touch screen or keyboard 276a, 276b (collectively 276) and/or a pointing device 277a, 277b (collectively 277) such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278a, 278b (collectively 278) may be coupled to the system bus via a video interface, such as a video adapter. The satellite node server computer system 206 can include other output devices, such as speakers, printers, etc.

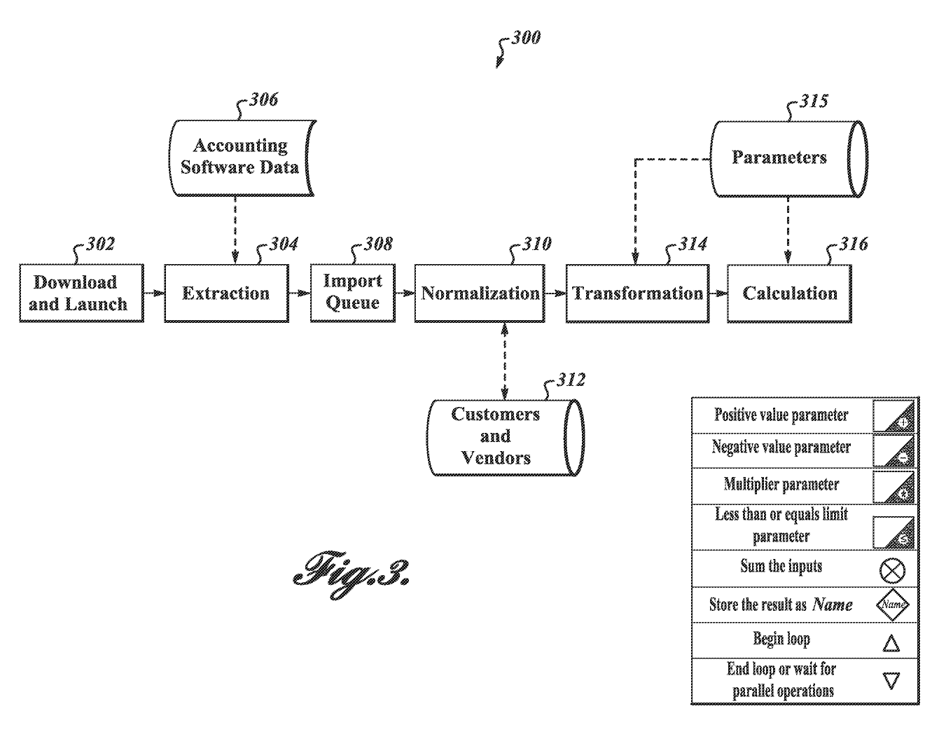

FIG. 3 shows a high level method 300 of operating an asset-based lending management computer system, according to one illustrated embodiment.

At 302, the asset-based lending management computer system starts. In particular, the asset-based lending management computer system may execute the method 300 in response to powering up or receiving a command.

At 304, the asset-based lending management computer system extracts, imports or otherwise retrieves asset-related information 306 from computing systems and/or nontransitory computer readable medium of one or more borrowers. The asset-based lending management computer system may directly extract, import or otherwise retrieve the asset-related information 306 from an accounting package or module and/or an ERP system or module, or may make API calls to an accounting package or module and/or an ERP system or module. The accounting package or module and/or an ERP system or module may be resident on borrower computing system(s) or on a system controlled by a third party such as an accountant or other agent of the borrower. The asset-based lending management computer system may extract, import or otherwise retrieve selected asset-related information 306 from the accounting or ERP module or any other source of asset-related information (e.g., Quickbooks® online). The selected asset-related information may be that which is specified by a lender.

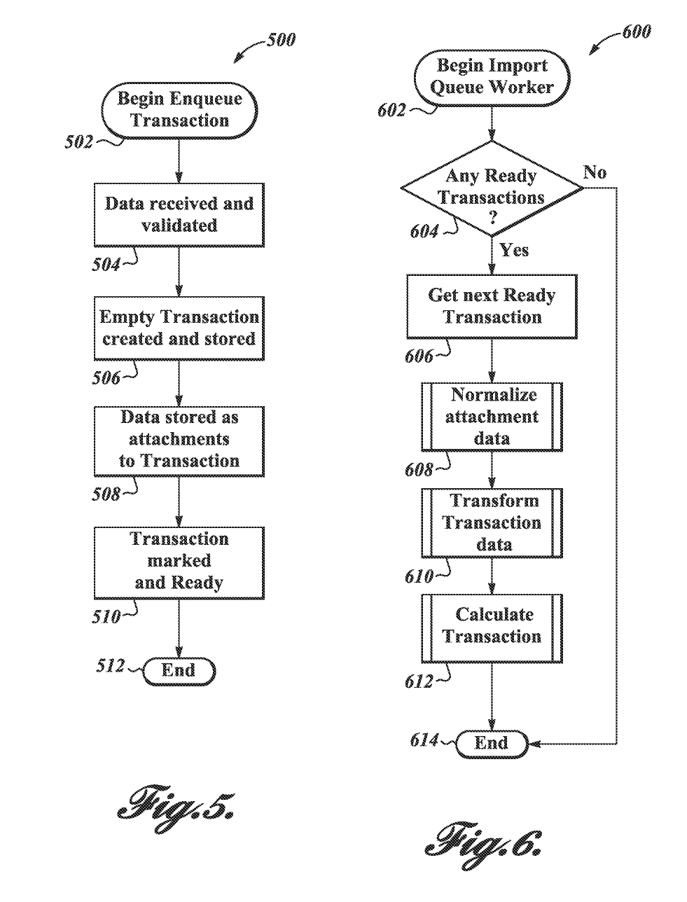

At 308, the asset-based lending management computer system may optionally queue the extracted, imported or retrieved asset-related information to an import queue. The import queue provides storage for the asset-related information until the asset-based lending management computer system is ready to further process the asset-related information. The optional queuing is explained in more detail below, particularly in reference to FIG. 5, below.

At 310, the asset-based lending management computer system normalizes the queued asset-related information. Normalization may include normalizing with respect to customers and vendors information 312 regarding various customers and/or vendors of a respective borrower. The customer and vendors information 312 may be stored locally at the asset-based lending management computer system or may be retrieved from a system or nontransitory processor-readable storage medium associated with the respective borrower. Normalization is explained in more detail below, particularly in reference to FIG. 7, below.

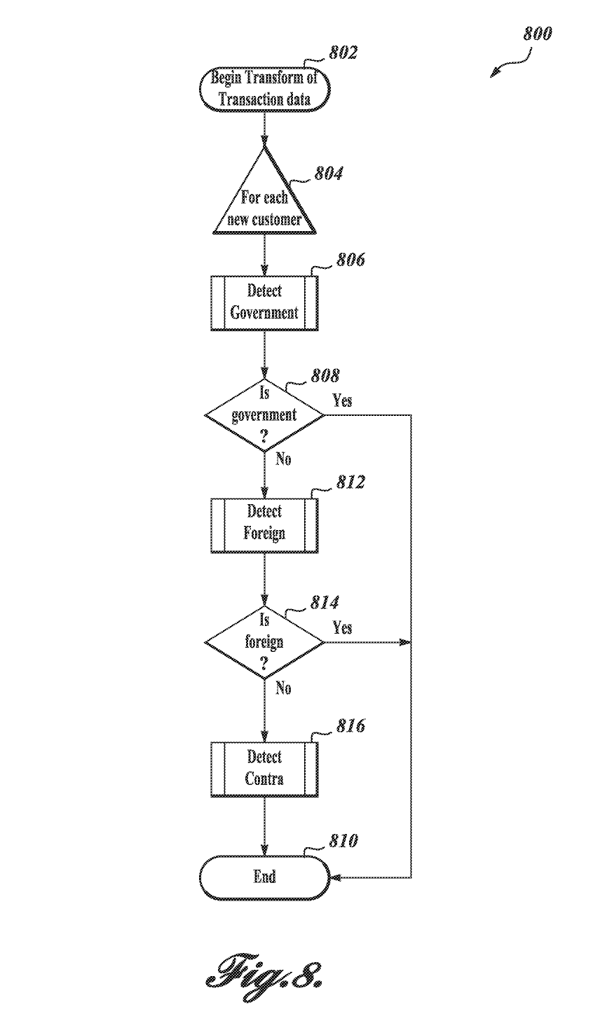

At 314, the asset-based lending management computer system performs transaction transformation on the normalized asset-related data. The transaction transformation may rely on one or more parameters 315. The parameters 315 may, for example, be parameters specified by a lender, which may be stored in nontransitory processor-readable storage media. Transformation of transaction data is explained in more detail below, particularly in reference to FIG. 8, below.

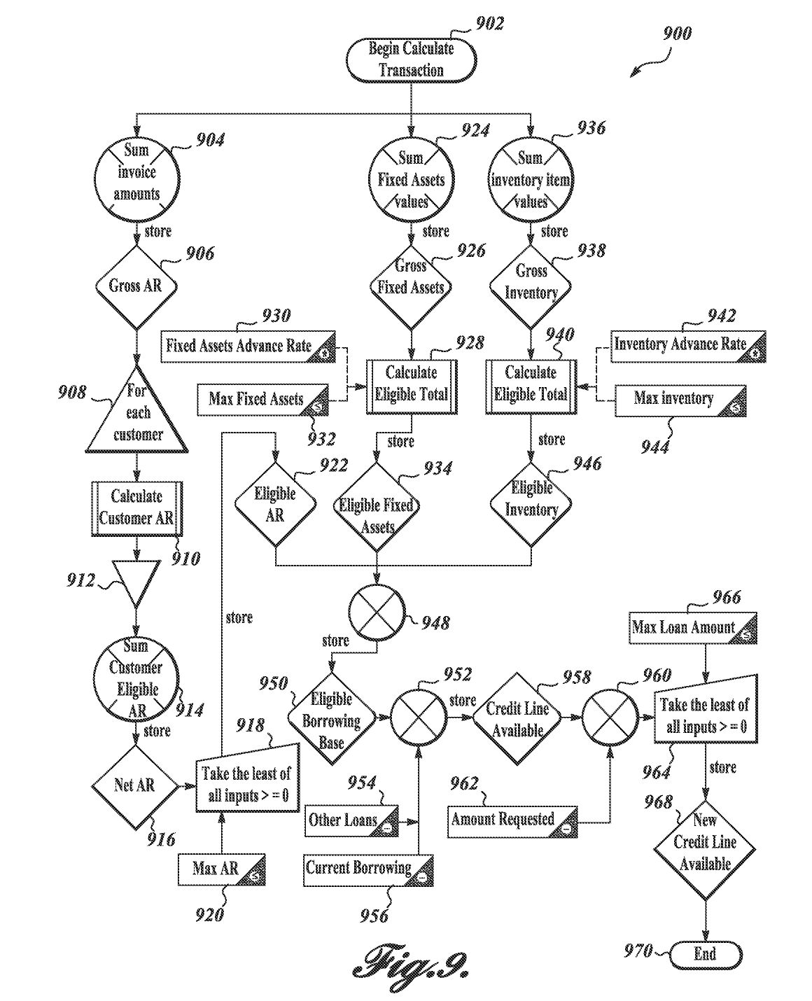

At 316, the asset-based lending management computer system performs calculations on the transaction transformed asset-related data. The calculations may rely on one or more parameters 315. The parameters 315 may, for example, be parameters specified by a lender, which may be stored in nontransitory processor-readable storage media. Performing of calculations is explained in more detail below, particularly in reference to FIG. 9, below.

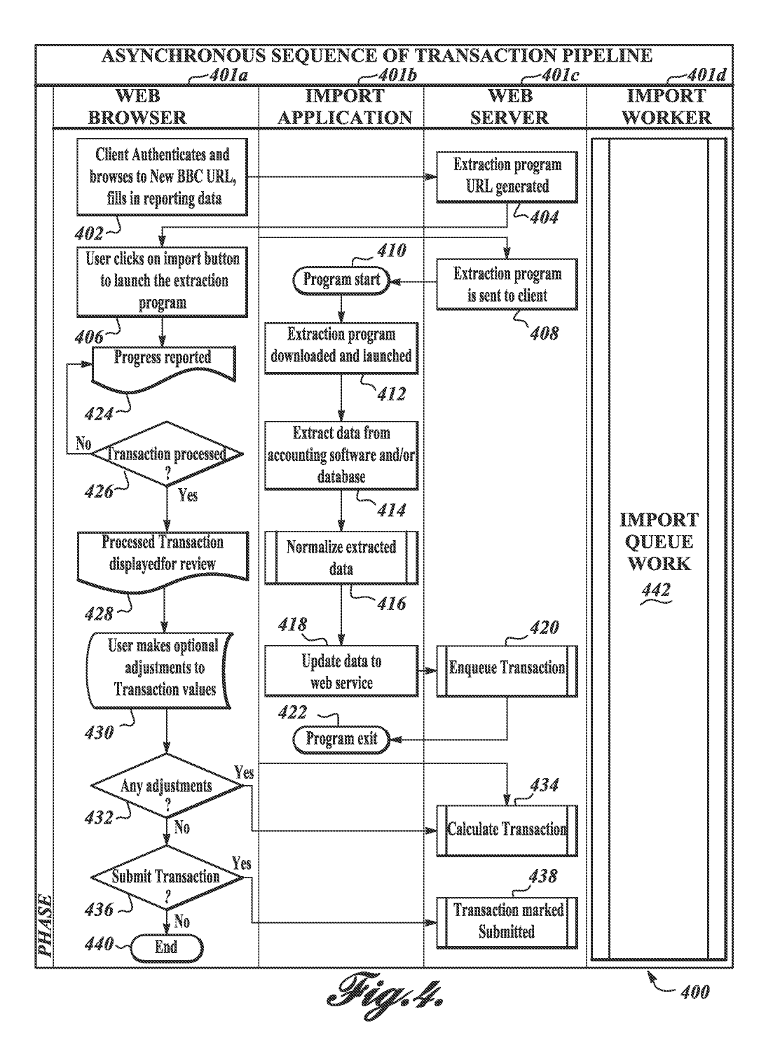

FIG. 4 shows an asynchronous sequence 400 of a transaction pipeline as used in an asset-based lending management computer system, according to one illustrated embodiment. The asynchronous sequence 400 is illustrated with respect to four modules or entities, namely a Web browser 401a, an import application 401b, a Web server 401c, and an import queue worker application 401d. Description of the various acts performed by these modules or entities and the flow between in executing a series of transactions them follows.

At 402, a client (e.g., borrower, lender) accesses an asset-based lending management computer system via the Web browser 401a operating on the client's end user computer system. In particular, the client may authenticate and browse to a particular URL. The client may enter in a reporting date indicative of a date for which a report shall be generated. The reporting date may default to a current date, a previous month end data or a lender supplied date, etc.

In response, the Web server 401c operating or at the asset-based lending management computer system generates an extraction program URL. The Web server 401c supplies the extraction program URL to the client via the Web browser 401a. The URL may be supplied as a hyperlink, for example as a user selectable icon such as an import button on a Webpage, in a conventional fashion for a hyperlink.

At 406, the client or end user selects an import button user selectable icon on the Web page to launch the import application 401b, which may also be referred to as an extraction program. At 408, the Web server 401c sends the import application or extraction program to the client.

At 410, the import application or extraction program 401b starts, for example operating on one or more computer systems associated with the client (e.g., borrower). At 412, the import application or extraction program is optionally downloaded, and launched. At 414, the import application or extraction program extracts data from accounting software or modules, ERP software or module, and/or an accounting and/or ERP database. The accounting software or modules, ERP software or module, and/or an accounting and/or ERP database may reside on one or more computer systems or nontransitory media controlled by the client (e.g., borrower) or by a third party that maintains such information for the client. The asset-related information may be extracted directly, or via one or more API calls made to the accounting and/or ERP software or module(s) or database(s).

At 416, the import application or extraction program 401b normalizes the extracted asset-related data. As previously noted, normalization is discussed in more detail in reference to FIG. 7, below.

At 418, the import application or extraction program 401b uploads the normalized data for processing, for example to the Web server 401c. At 420, the Web service enqueues the transaction including the normalized extracted asset-related data uploaded via the Web service. The import application or extraction program exits, ends or terminates at 422.

During the above process, the Web browser 401a provides progress reports to the client or user at 424. At 426, the Web browser 401a determines whether the transaction has been processed. The Web browser 401a executes a wait loop, returning to 424 until a current transaction has been processed.

At 428, in response to the current transaction having been processed, the Web browser 401a presents the processed transaction for review by the client or end user. The processed transaction may be presented in a variety of ways, for example as a visual display of various transaction related data using any of variety of formats. Such may allow the client or end user to visually inspect the transaction for accuracy. If corrections or adjustments are required or desirable, the user optionally makes the corrections or adjustments to the transaction values at 430. At 432, the Web browser 401a determines whether any corrections or adjustments to the transaction values have been made. If corrections or adjustments to the transaction values have been made, those corrections or adjustments are provided to the Web server 401c. In response, the Web server 401c calculates the transaction with the corrected or adjusted transaction values at 434. The Web server 401c returns the re-calculated transaction to the Web browser 401a to again be presented at 428 for review by the client or end user. This may be repeated until there are no further corrections or adjustments. In response, the Web browser 401a submits the transaction to the Web server 401c at 436.

At 438, the Web server 401c marks the transaction as submitted, for inclusion in an import queue work 442. The import application or extraction program terminates or ends at 440. Alternatively, the import application or extraction program may normalize asset-related data, for instance in a manner similar to, or even identical, to that described in reference to FIG. 5.

The import queue worker application 401d processes the submitted transactions in the import queue work 442. The processing of the submitted transactions are discussed in detail below.

FIG. 5 shows a method 500 of enqueueing a transaction for use in operation of an asset-based lending management system, according to one illustrated embodiment.

At 502, the Web server 401c (FIG. 4) begins the enqueueing transaction method 500, for example in response to extraction and normalization of asset-related data associated with a particular borrower.

At 504, the Web server 401c receives and validates the normalized asset-related data received from the import application or extraction program 401b (FIG. 4). Validation may include validating that all discrete pieces of data are present and/or that various values are within expected limits or ranges.

At 506, the Web server 401c creates and stores an empty transaction object. The transaction object may, for example, take the form of a data structure, for instance a record with fields to store various pieces of asset-related data.

At 508, the Web server 401c stores data as attachments to the transaction object.

At 510, the Web server 401c marks the transaction as ready for further processing. The Web server 401c may set a value of a flag associated with the transaction object or with a queue implemented for instance as a linked list or other data structure.

At 512, the transaction enqueueing method 500 may terminate until called again. Alternatively, the transaction enqueueing method 500 may run concurrently with other methods or processes, for example, as one of multiple threads on a multi-threaded processor system.

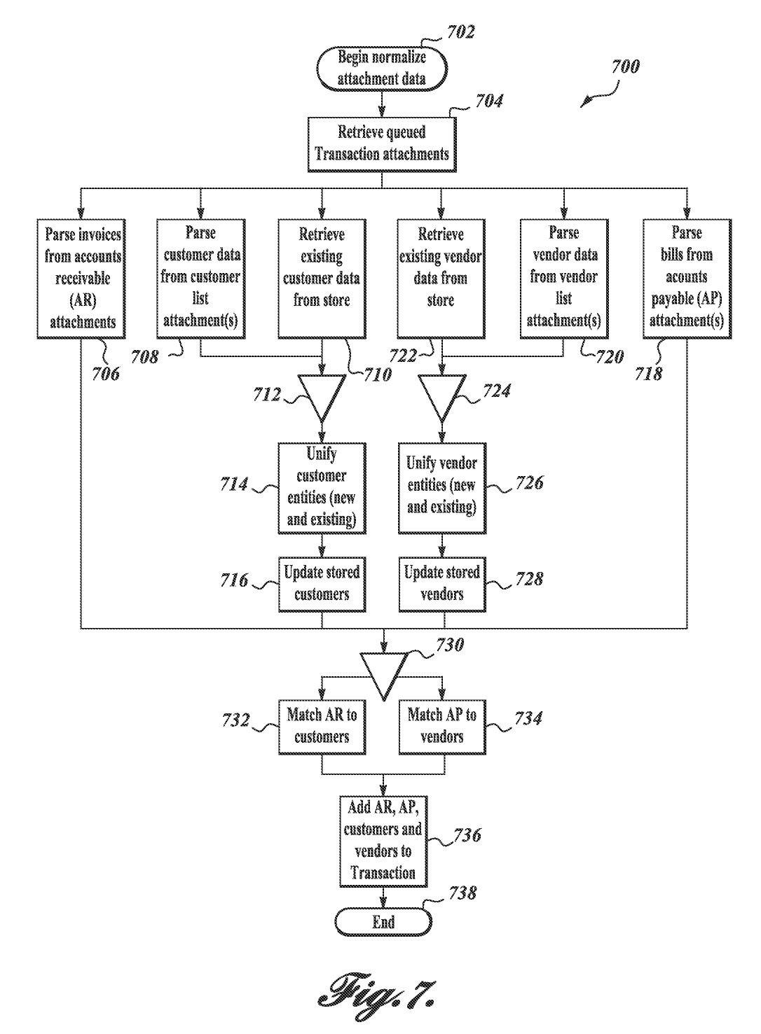

FIG. 6 shows a method 600 of processing transactions in operation of an asset-based lending management system, according to one illustrated embodiment.

At 602, an import worker application 401d (FIG. 4) starts. The import worker application 401d may start in response to an application of power, receipt of a transaction in the import queue, periodically or even aperiodically, for instance in response to a query.

At 604, the import worker application 401d determines whether there are any transactions ready for processing in the import queue work 442 (FIG. 4). In response to determining that there are transactions ready for processing, at 606 the import worker application 401d gets a next transaction in the import queue ready for processing. If there are no transactions ready, the transaction processing method 600 terminates immediately at 614.

At 608, the import worker application 401d normalizes the attachment data attached to the transaction object. Normalization is discussed in detail further herein, in particular in reference to FIG. 7 below.

At 610, the import worker application 401d transforms the transaction data. Transformation of transaction data is discussed in detail further herein, in particular with reference to FIG. 8 below.

At 612, the import worker application 401d calculates the transaction using the normalized and transformed transaction data. Calculation is discussed in detail further herein, in particular in reference to FIG. 7 below.

When finished with the calculations, the transaction processing method 600 may terminate at 614 until called again. Alternatively, the transaction processing method 600 may run concurrently with other methods or processes, for example, as one of multiple threads on a multi-threaded processor system.

FIG. 7 shows a method 700 of normalizing attachment data in operation of an asset-based lending management system, according to one illustrated embodiment.

At 702, the import worker application 401d (FIG. 4) begins the normalizing attachment data method 700. The normalizing attachment data method 700 may start in response to an application of power, receipt of a call from the import application or extraction program 401b (FIG. 4) or act 608 (FIG. 6), periodically or even aperiodically, for instance in response to a query.

At 704, the import worker application 401d retrieves queued transaction attachments from the import queue work 442a (FIG. 4). As the name implies, transactions may be retrieved and processed on a first in, first out basis.

At 706, the import worker application 401d parses invoices from one or more accounts receivable attachment(s), if any. Each invoice represents a statement of account or bill for payment sent or otherwise presented to a customer for payment by a respective borrower. At 708, the import worker application 401d parses customer data from one or more customer list attachment(s), if any. At 710, the import worker application 401d retrieves existing customer data from a store of customer data which may be stored on one or more nontransitory processor-readable storage medium. As indicated at 712, the import worker application 401d may execute a loop, continuing to parse customer data and/or retrieve existing customer data until complete.

At 714, the import worker application 401d unifies customer entities including both new and existing customers. Such allows differences in customer names to be resolved, and the correct amounts of accounts receivable allocated, assigned or mapped to the correct responsible entity. Thus, misspellings of customer names may resolved. Instances where the same customer entity is sometimes referred to one way (e.g., corporation) and another way (e.g., company), or yet another way (e.g., omitting the business form of the entity) can be resolved. Additionally, or alternatively, instances where two seemingly different but related businesses may be identified can be resolved. For instance, a parent and wholly owned subsidiary, or two wholly owned subsidiaries owned by a common parent may be identified as essentially constituting a single common entity for purposes of asset-based lending.

At 716, the import worker application 401d updates stored customer information in a nontransitory processor-readable storage medium. Such may include adding new variations on entity names identified via the process of unifying customer entities. Such customer information may be stored to any of a variety of data structures, for instance records, tables, linked lists, or relational databases. The stored customer information may be used to expedite future review of asset-related information.

At 718, the import worker application 401d parses bills from accounts payable attachments, if any. Each bill represents a statement of account or bill for payment received or otherwise presented to a respective borrower for payment from a vendor. At 720, the import worker application 401d parses vendor data from vendor list attachments, if any. At 722, the import worker application 401d retrieves existing vendor data from a store of vendor data, which may be stored on one or more nontransitory processor-readable storage medium. As indicated at 724, the import worker application 401d may execute a loop, continuing to parse vendor data from vendor list attachments and/or retrieve existing vendor data until complete.

At 726, the import worker application 401d unifies vendor entities, including both new and existing vendors. Such allows differences in vendor names to be resolved, and the correct amounts of accounts payable allocated, assigned or mapped to the correct responsible entity. Thus, misspellings of vendor names may resolved. Instances where the same vendor entity is sometimes referred to one way (e.g., corporation) and another way (e.g., company), or yet another way (e.g., omitting the business form of the entity) can be resolved. Additionally, or alternatively, instances where two seemingly different but related businesses may be identified can be resolved. For instance, a parent and wholly owned subsidiary, or two wholly owned subsidiaries owned by a common parent may be identified as essentially constituting a single common entity for purposes of asset-based lending.

At 728, the import worker application 401d updates stored vendor information in a nontransitory processor-readable storage medium. Such may include adding new variations on entity names identified via the process of unifying vendor entities. Such vendor information may be stored to any of a variety of data structures, for instance records, tables, linked lists, or relational databases. The stored vendor information may be used to expedite future review of asset-related information.

As indicated at 730, the import worker application 401d may wait for parallel operations with respect to the customer and vendor unification to be performed. For example, the processing of invoices, accounts receivable and customer information may run in parallel with the processing of bills or account payable and vendor information.

At 732, the import worker application 401d matches accounts receivable to customers. At 734, the import worker application 401d matches accounts payable to vendors.

At 736, the import worker application 401d adds accounts receivable, accounts payable, customers and vendors to the transaction object.

The normalize attachment data method 700 terminates at 738 until called again. Alternatively, the normalize attachment data method 700 may run concurrently with other methods or processes, for example, as one of multiple threads on a multi-threaded processor system.

FIG. 8 shows a method 800 of transforming data in operation of an asset-based lending management system, according to one illustrated embodiment.

At 802, the import worker application 401d (FIG. 4) begins the transform transaction data method 800. The transform transaction data method 800 may start in response to an application of power, receipt of a call from the import application or extraction program 401b (FIG. 4) or act 610 (FIG. 6), periodically or even aperiodically, for instance in response to a query.

As indicated at 804, the import worker application 401d starts a loop for each new customer.

At 806, the import worker application 401d detects whether the customer is a governmental entity. The import worker application 401d may rely on stored customer information. For example, stored customer information may include the names of various governmental entities stored in a list or table. Alternatively, a record or other data structure associated with a customer may include a field, flag or other element that indicates whether or not the customer is a governmental entity. Governmental entities can take a variety of forms, including sovereign governments or countries, federal states, agencies, departments or other organizations of such countries or states, possibly including semi-governmental organizations (e.g., U.S. Post Office). Such may also encompass quasi-governmental organizations such as the United Nations or agencies thereof.

At 808, the import worker application 401d determines whether the customer is a governmental entity. Such may be based on a user identifying the customer as being a government entity. Additionally or alternatively, other criteria may be employed, such as the inclusion of key words such as “state”, “agency”, “commission” or “bureau”. Again, the import worker application 401d may check a data structure for an indication of whether a customer is a governmental entity. If the customer is a governmental entity, the method 800 terminates at 810. Otherwise, if the customer is not a governmental entity, control passes to 812.

At 812, the import worker application 401d detects whether the customer is a foreign-based entity. The import worker application 401d may rely on stored customer information. For example, stored customer information may include the names of various foreign located customers stored in a list or table. Alternatively, a record or other data structure associated with a customer may include a field, flag or other element that indicates whether or not the customer is a foreign-based entity. Alternatively, or additionally, the import worker application 401d may inspect an address and/or telephone number stored for the particular customer. Foreign-based entities can take a variety of forms, including companies or businesses principally located overseas, or with a parent or holding company that is responsible for paying invoices which is located overseas.

At 814, the import worker application 401d determines if the customer is a foreign-based entity. Again, the import worker application 401d may check a data structure for an indication of whether a customer is a governmental entity, for instance a field, flag, address or portion thereof (e.g., Zip Code) or telephone number or portion thereof (e.g., Area Code or International Dialing Code). If the customer is a foreign-based entity, the method 800 terminates at 810. Otherwise, if the customer is not a foreign-based entity, control passes to 816.

At 816, the import worker application 401d detects whether the customer is a contra account. A contra account occurs where an entity is both a customer and a vendor for the borrower. Thus, the borrower sends invoices to the entity so has accounts receivable owing from the entity, but also receives bills from the entity so has accounts payable it owes to the entity. It may be useful to identify contra accounts since, accounts payable may be used to offset accounts receivable should it become necessary for the lender to reach into the assets securing a loan or advance.

The transform transaction data method 800 terminates at 810 until called again. Alternatively, the transform transaction data method 800 may run concurrently with other methods or processes, for example, as one of multiple threads on a multi-threaded processor system.

FIG. 9 shows a method 900 of calculating a transaction in an operation of an asset-based lending management system, according to one illustrated embodiment. The method 900 may, for example, be used in calculating a transaction 434 of method 400 (FIG. 4).

The transaction calculation method 900 may start at 902 in response to an application of power, receipt of a call from the import application or extraction program 401b (FIG. 4) or act 612 (FIG. 6), periodically or even aperiodically, for instance in response to a query. The method 900 may, for example, include three branches, one to process invoices, one to process fixed assets, and one to process inventory. Each is described in turn, below.

The transaction calculation method 900 may process invoices. In particular, starting at 904 an import worker application 401d (FIG. 4) sums invoice amounts. At 906, the import worker application 401d stores the sum as a gross account receivable value.

As indicated at 908, the import worker application 401d begins executing a loop for each customer. In the loop, the import worker application 401d calculates a customer accounts receivable amount for the respective customer at 910. This may include calculating the accounts receivable over a plurality of invoices for the respective customer, for example monthly invoices over two or more months. The loop terminates at 912. Once all customer accounts receivable have been calculated for all customers, control passes to 914 where the import worker application 401d sums the eligible customer accounts receivable amounts. At 916, the import worker application 401d stores the sum as a net accounts receivable amount.

At 918, the import worker application 401d determines the least of all net accounts receivable amounts that are greater than or equal to zero. The import worker application 401d may apply a maximum accounts receivable amount 920 to the value to place a limit on the maximum allowed accounts receivable amount. The maximum accounts receivable amount may be specified by a lender, and may be stored in nontransitory processor-readable storage media. At 922, the import worker application 401d stores the resulting value as an eligible accounts receivable amount.

The import worker application 401d may process fixed assets sequentially or in parallel with the processing of invoice amounts. Particularly, at 924 the import worker application 401d sums the fixed asset values. At 926, the import worker application 401d stores the sum as a gross asset value.

At 928, the import worker application 401d calculates an eligible total, relying on a fixed assets advanced rate 930 and a maximum fixed asset value 932. The fixed assets advanced rate 930 and maximum fixed asset value 932 may be specified by a lender, and may be stored in nontransitory processor-readable storage media. At 934, the import worker application 401d stores the calculated eligible total as an eligible fixed asset value.

The import worker application 401d may process inventory in parallel or sequentially with the processing of invoice amounts and/or fixed asset values and/or raw work in progress (WIP). In particular, start at 936 the import worker application 401d sums inventory item values. At 938, the import worker stores the sum as a gross inventory amount. At 940, the import worker application 401d calculates an eligible total employing an inventory advance rate 942 and a maximum inventory amount 944. The inventory advance rate 942 and/or maximum inventory amount 944 may be specified by a lender, and may be stored in nontransitory processor-readable storage media. At 946, the import worker application 401d stores the calculated eligible total as an eligible inventory value.

The processing of the various assets (e.g., invoices or accounts receivable, fixed assets, inventory) are brought together starting at 948. In particular, at 948 the import worker application 401d sums the eligible accounts receivable value, the eligible fixed assets value, and/or the eligible inventory value. At 950, the import worker application 401d stores the sum as an eligible borrowing base value. Such reflects the eligible amount of all assets which may serve as collateral for a loan.

At 952, the import worker application 401d sums the eligible borrowing base value with other loan amounts 954 and current borrowing amounts 956. In particular, the other loan amounts 954 and current borrowing 956 are subtracted from the eligible borrowing base. The other loan amounts 954 and/or current borrowing amounts 956 may be supplied by the borrower and/or by the lender. At 958, the import worker application 401d stores the sum as a credit line available amount.

At 960, the import worker application 401d sums the credit line available amount with an amount requested value 962. Such determines an amount of credit available. The amount requested 962 may be supplied by the borrower and/or by the lender.

At 964, the import worker application 401d takes the least of all inputs greater than and equal to zero. The import worker application 401d may employ a maximum loan amount 966. The maximum loan amount 966 may be supplied by the borrower and/or by the lender, and may be stored in nontransitory processor-readable storage media. The import worker application 401d stores the resulting value as a new credit line available amount 968.

The transaction calculation method 900 terminates at 970 until called again. Alternatively, the transaction calculation method 900 may run concurrently with other methods or processes, for example, as one of multiple threads on a multi-threaded processor system.

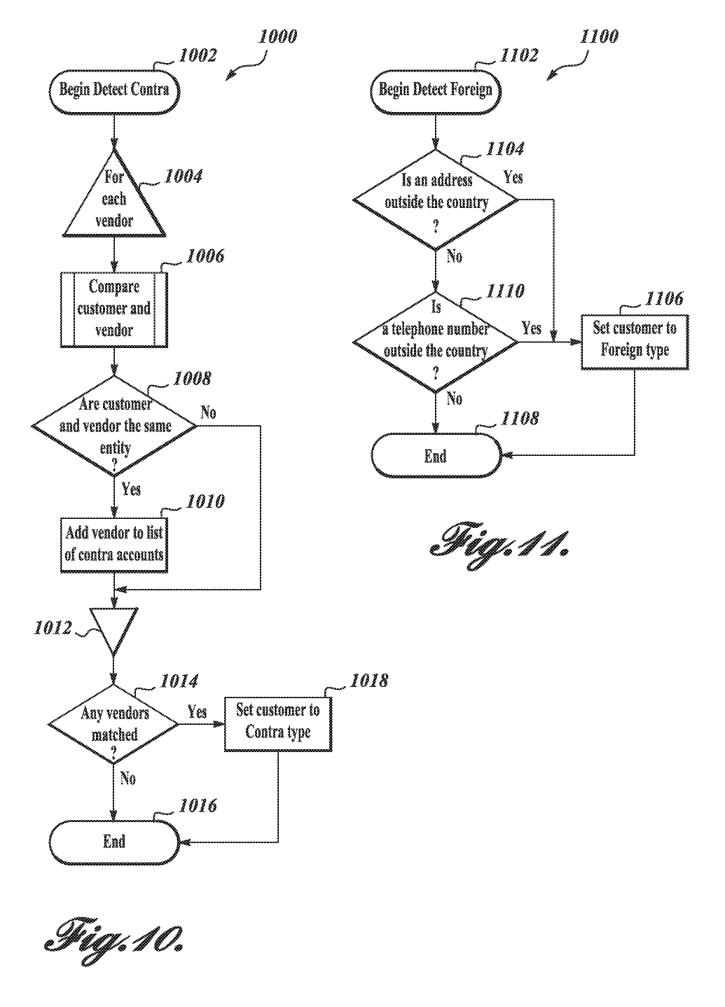

FIG. 10 shows a method 1000 of detecting contra accounts (i.e., contras) in operation of an asset-based lending management system, according to one illustrated embodiment. The method 1000 may, for example, be used in detecting contras 816 of method 800 (FIG. 8).

The detect contras method 1000 starts at 1002, for example in response to an application of power, receipt of a call from the transform transaction data method 800 at 816 (FIG. 8), or periodically or even aperiodically, for instance in response to a query.

As indicated at 1004, the import worker application 401d (FIG. 4) starts a loop to process each vendor. At 1006, the import worker application 401d compares a customer and a vendor. For example, the import worker application 401d may compare one or more customer names or other customer identifiers with one or more vendor names or other vendor identifiers. As previously noted, variations of customer or vendor names or other identifiers may be stored. Such may, for instance include common misspellings, abbreviations, or variations in the business form (e.g., company, corp., corporation) which may occur from time to time in identifying a given business entity. For example, the import worker application 401d may compare one or more other customer related pieces of information with one or more other vendor related pieces of information. Pieces of information may include addresses, telephone numbers, facsimile numbers, electronic mail addresses, Webpage URLs, or any other information that will likely identify the customer or vendor.

At 1008, the import worker application 401d determines if the customer and vendor are the same entity. Again, the import worker application 401d may compare one or more pieces of customer related information with one or more pieces of vendor related information, determining whether there is a match or approximate match. Optionally, the import worker application 401d may prompt a client or end user to confirm whether a match or approximate match should be treated as the same entity. Such may include displaying various pieces of information about the entities (e.g., customer, vendor) to the client or end user to review.

If the import worker application 401d determines that the customer and vendor are the same entity, the import worker application 401d adds the vendor to a list of contra accounts at 1010, and control then passes to the end of the loop at 1012. If the import worker application 401d determines that the customer and vendor are not the same entity, control passes directly to 1012.

At 1014, the import worker application 401d determines whether any matches were found. If the import worker application 401d determines that any vendors were matched to customers, the import worker application 401d sets the respective customer to a contra type customer at 1018, and terminates the method 1000 at 1016. The import worker application 401d may set a flag or field in a respective customer object or other data structure to indicate the contra type. Otherwise control passes directly to 1016, where the method 1000 terminates until called again. Alternatively, the detect contra method 1000 may run concurrently with other methods or processes, for example, as one of multiple threads on a multi-threaded processor system.

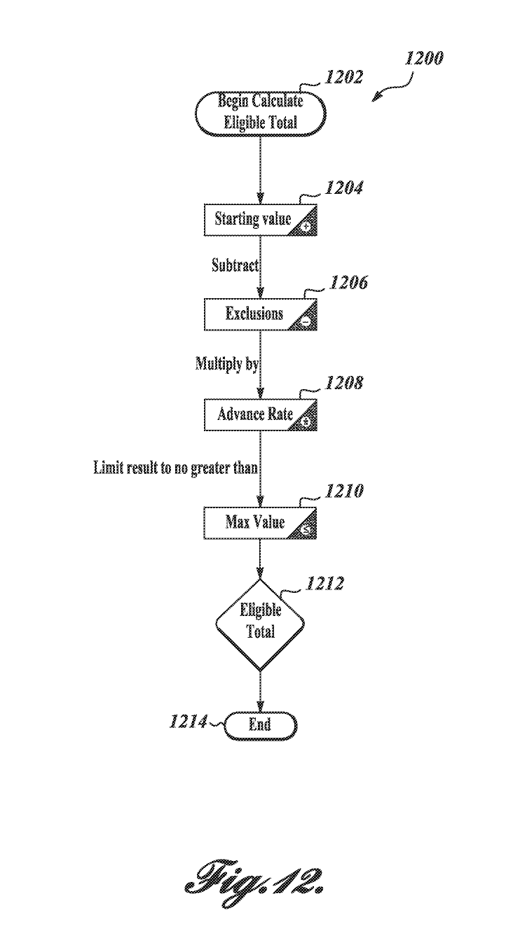

FIG. 11 shows a method 1100 of detecting foreign-based assets in operation of an asset-based lending management system, according to one illustrated embodiment. The detect foreign customers method 1100 may, for example, be used in detecting foreign customers 814 of method 800 (FIG. 8).

The detect foreign customers method 1100 starts at 1102, for example in response to an application of power, receipt of a call from the transform transaction data method 800 at 814 (FIG. 8), or periodically or even aperiodically, for instance in response to a query.

At 1104, the import worker application 401d (FIG. 4) determines if an address associated with the respective customer is located outside the country. If the import worker application 401d determines that the address associated with the respective customer is located outside the country, the import worker application 401d sets the customer to a foreign type at 1106, and passes control to 1108 where the method 1100 terminates. If the import worker application 401d determines that the address associated with the respective customer is not located outside the country, control passes to 1110.

At 1110, the import worker application 401d determines whether a telephone number associated with the respective customer is for a telephone service located outside the country. Additionally or alternatively, the import worker application 401d may rely on user identification of foreign customers. Additionally or alternatively, the import worker application 401d may check uniform resource locators (URLs) or other addresses associated with a customer to automatically detect foreign customers. If the import worker application 401d determines that the telephone number associated with the respective customer is for a telephone service located outside the country, the import worker application 401d sets the customer to a foreign type at 1106, and passes control to 1108 where the method 1100 terminates. If the import worker application 401d determines that the telephone number associated with the respective customer is not for a telephone service located outside the country, control passes directly to 1108 where the method 1100 terminates until called again. Alternatively, the detect foreign method 1100 may run concurrently with other methods or processes, for example, as one of multiple threads on a multi-threaded processor system.

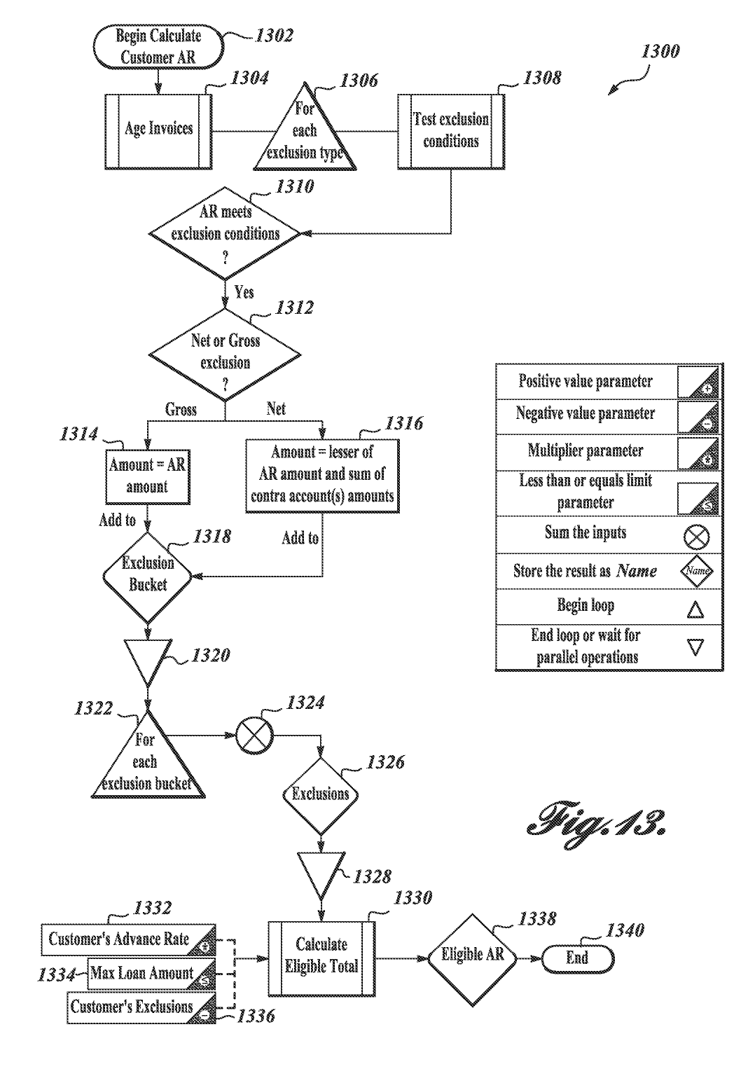

FIG. 12 shows a method 1200 of calculating eligible totals in operation of an asset-based lending management system, according to one illustrated embodiment. The calculate eligible totals method 1200 may, for example, be used in calculating eligible customer accounts receivable 910, calculating eligible totals of fixed assets 928 and/or eligible totals of inventory 940 of the calculate transaction method 900 (FIG. 9). In particular, the calculate eligible totals method 1200 applies various rules, typically specified by the lender, to the asset values to determine whether the asset values that are eligible for establishing an eligible borrowing base for the lender to evaluate.

The calculate eligible totals method 1200 starts at 1202, for example in response to an application of power, receipt of a call from the calculate transaction method 900 at 910, 928 and/or 940 (FIG. 9), or periodically or even aperiodically, for instance in response to a query.

At 1204, the import worker application 401d (FIG. 4) determines a starting value. The starting value may take a variety of forms, for example a sum of customer accounts receivable (i.e., gross accounts receivable 906), sum of fixed assets (i.e., gross fixed assets 926), and/or sum of inventory (i.e., gross inventory 938).

At 1206, the import worker application 401d subtracts exclusions from the starting value. The exclusions may be specified by the lender, and may be stored in nontransitory processor-readable storage media. Exclusions may take a variety of forms. For example, exclusions may include the types of assets (e.g., accounts receivable, fixed assets, inventory) that a lender will consider when deciding on making a loan or advance or in evaluating compliance with loan conditions or terms. The lender may apply exclusions globally, or on a borrower-by-borrower basis, or even on a customer-by-customer (i.e., customer of the borrower) basis. Exclusions may be applied on an asset type basis, different exclusions applying to different asset types.

With respect to accounts receivable or invoices, exclusions may, for example, include excluding aged accounts receivable older than some defined period. Such may also include excluding all accounts receivable, regardless of respective age, for customers who as a percentage have invoice amounts over a certain age. Also for example, exclusions may include excluding accounts receivable based on a concentration percentage (i.e., too high a percentage in one or a few customers), for instance amounts above a concentration percentage. Also for example, exclusions may include excluding contra accounts or portions thereof, either net or gross. Also for example, exclusions may include excluding accounts receivable associated with government accounts, foreign accounts and/or related accounts or contra accounts. Also for example, exclusions may include excluding accounts receivable based on cross-aging, credit memorandums, etc.

With respect to fixed asset type assets, the lender may set exclusion parameters on a type of fixed asset, location of fixed asset, total amount of fixed assets allowable, and/or status (e.g., clear of liens) of the fixed asset.

With respect to inventory type assets, the lender may set exclusion parameters on an inventory category basis. For example, the lender may set different exclusion parameters for raw goods, work in progress goods, finished goods, and/or in-transit goods.

At 1208, the import worker application 401d multiplies the sum of the starting value and exclusions by an advance rate. The advance rate may be supplied by the lender, and may be stored in nontransitory processor-readable storage media. The advance rate may, for example, set a lender-specified discount to account for various factors such as inability to recoup full value of some assets, costs associated with recouping value on assets, etc. Such may provide a margin of error when assessing the entire amount recoverable via assets which secure a loan or advance.

At 1210, the import worker application 401d limits the product of the sum and the advance rate by a maximum value. The maximum value may be supplied by the lender, and may be stored in nontransitory processor-readable storage media.

At 1212, the import worker application 401d stores the result as an eligible total value.

The calculate eligible total method 1200 terminates at 1214 until called again. Alternatively, the calculate eligible total method 1200 may run concurrently with other methods or processes, for example, as one of multiple threads on a multi-threaded processor system.

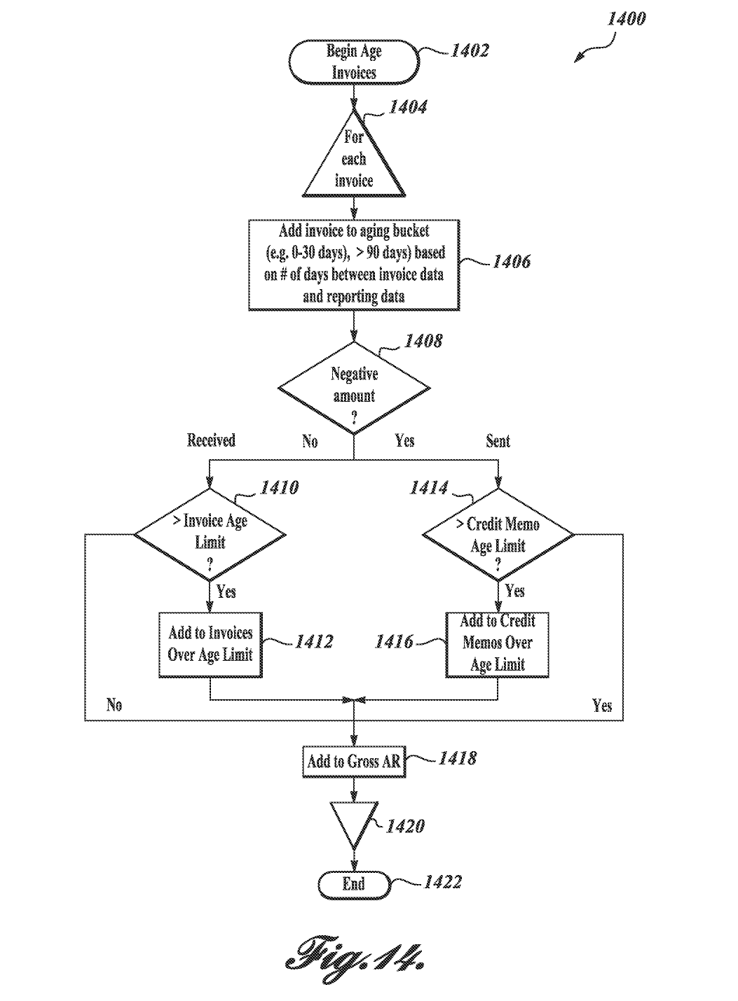

FIG. 13 shows a method 1300 of calculating accounts receivable in operation of an asset-based lending management system, according to one illustrated embodiment. The accounts receivable calculation method 1300 may, for example, be used in calculating customer accounts receivable 910 of the calculation transaction method 900 (FIG. 9).

The accounts receivable calculation method 1300 starts at 1302, for example in response to an application of power, receipt of a call from the calculate transaction method 900 at 920 (FIG. 9), or periodically or even aperiodically, for instance in response to a query.

At 1304, the import worker application 401d ages invoices. Aging invoices may include evaluating and/or segregating invoices by date. For example, monthly invoices may be aged relative to a then current date, moving from 30 days, to 60 days, to 90 days due. The age may be determined based on a date that an invoice was issued. Alternatively, age may be based on date that payment for an invoice is due. For instance, many invoices are due 30 days after issue. Relying on the date of issue rather than due date for payment may advantageously prevent manipulation by an unscrupulous borrower. Aging of invoices is discussed in more detail with reference to FIG. 14, below.

As indicated at 1306, the import worker application 401d executes an exclusion processing loop for each exclusion type. At 1308, the import worker application 401d tests exclusion conditions. At 1310, the import worker application 401d determines whether the accounts receivable meets the exclusion conditions. If the accounts receivable meets the exclusion conditions, the import worker application 401d determines whether the exclusion is a net or gross exclusion at 1312. If the exclusion is a net exclusion, the import worker application 401d sets an amount equal to the accounts receivable amount at 1314. If the exclusion is a gross exclusion, the import worker application 401d sets the amount equal to the lesser of the accounts receivable amount and a sum of contra account amounts at 1316. At 1318, the import worker application 401d stores the amount as an exclusion bucket. As indicated at 1320, the exclusion processing loop terminates.

As indicated at 1322, the import worker application 401d executes a sum exclusions loop for each exclusion bucket value. At 1324, the import worker application 401d sums the various exclusion bucket values for the customer. At 1326, the import worker application 401d stores the resulting sum as an exclusion amount. As indicated at 1328, the sum exclusions loop terminates on completion of summing all exclusion bucket values.

At 1330, the import worker application 401d calculates an eligible total amount. The import worker application 401d may employ a customer's advance rate 1332, maximum accounts receivable 1334 and exclusions 1336. The customer's advance rate 1332, maximum accounts receivable 1334 and/or exclusions 1336 may be specified by the lender, and may be stored in nontransitory processor-readable storage media. In particular, in calculating the eligible total for the customer at 1330, the import worker application 401d may multiply the exclusions amount stored at 1326 by a customer's advance rate 1332. The import worker application 401d may limit the resulting amount by a customer's maximum accounts receivable amount 1334, which places a limit on the amount receivable which may be relied upon to collateralize a loan or advance. The import worker application 401d may subtract customer exclusions 1336 from the resulting amount. At 1338, the import worker application 401d stores the results as an eligible accounts receivable amount.

The calculate customer accounts receivable method 1300 terminates at 1340 until called again. Alternatively, the calculate customer accounts receivable method 1300 may run concurrently with other methods or processes, for example, as one of multiple threads on a multi-threaded processor system.

FIG. 14 shows a method 1400 of aging invoices in operation of an asset-based lending management system, according to one illustrated embodiment. The age invoices method 1400 begins at 1402 and may, for example, be useful in aging invoices 1304 of the calculate customer accounts receivable method 1300 (FIG. 13).

The age invoices method 1400 begins at 1402, for example, in response to an application of power, receipt of a call from the calculate customer accounts receivable method 1300 (FIG. 13) at 1304, or periodically or even aperiodically, for instance in response to a query.

As indicated at 1404, the import worker application 401d executes a loop for each invoice. At 1406, the import worker application 401d adds an invoice amount to an aging bucket, for example based on a number of days between the invoice date (e.g., date invoice issued) and a report date (e.g., current date). Invoice amounts may, for example, be categorized or segregated into buckets of: zero to thirty days, thirty to sixty days, sixty to ninety days, or greater than ninety days, based on the number of days between the invoice date and the reporting date.

At 1408, the import worker application 401d determines whether the aged bucket amount is a negative amount, or alternatively a positive amount. A positive amount is indicative of an account receivable, potentially collectable by the borrower. A negative amount is indicative of a credit memorandum issued by the borrower, hence discountable against accounts receivable by a customer.

If the import worker application 401d determines that the aged bucket amount is not a negative amount, the import worker application 401d determines whether the aged bucket amount is greater than an invoice age limit at 1410. If the import worker application 401d determines that the aged bucket amount is greater than the invoice age limit, the import worker application 401d adds the aged bucket amount to an invoice over age limit amount at 1412, and passes control to 1418. If not, control passes directly to 1418.

If the import worker application 401d determines at 1408 that the aged bucket amount is a negative amount, control passes to 1414. At 1414, the import worker application 401d determines whether the aged bucket value is greater than a credit memorandums age limit value. If the aged bucket value is greater than the credit memorandum age limit value, the import worker application 401d adds the aged bucket amount to a credit memorandums over age limit amount at 1416, and passes control to 1418. If not, control passes directly to 1418.

At 1418, the import worker application 401d adds the values to the gross accounts receivable amount. As indicated at 1420, the loop terminates once each invoice has been aged.

At 1422, the method 1400 terminates until called again. Alternatively, the age invoices method 1400 may run concurrently with other methods or processes, for example, as one of multiple threads on a multi-threaded processor system.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation of a trusted third party evaluation system that includes at least one processor, at least one nontransitory processor-readable medium, and at least one communications port, the method comprising:
receiving parameters input by the trusted third party evaluation system from at least a first lender computer system controlled by a first lender, the parameters input specifying a number of parameters imposed by at least the first lender;
receiving respective borrower accounting information including data and metadata for each of a number of borrowers by the evaluation system from each of a number of accounting modules executed on a number of source computer systems which are distinct from the first lender computer system, the data and metadata representative of a number of accounts maintained by each borrower, the data and metadata representative of a plurality of invoices; and
for each of a plurality of borrower accounts maintained by the first lender and logically associated with a respective one of the borrowers:
for each of the plurality of accounts maintained by the respective one of the borrowers:
for each of the plurality of invoices issued to or received from the respective one of the accounts:
determining an age of the respective invoice based on a first piece of metadata and a reporting date,
determining if the determined age of the respective invoice exceeds a defined age limit,
adding a total amount of the respective invoice to an over aged invoice limit value if the determined age of the respective invoice exceeds the defined age limit,
adding the amount of the respective invoice to a gross accounts receivable value, and
for each of the plurality of invoices issued to the respective one of the accounts:
determining an exclusion amount, and
determining an eligible total accounts receivable value for the respective account based at least in part on the determined exclusion amount; and
determining an eligible total accounts receivable value for the respective account based at least in part on the determined eligible total accounts receivable values of the plurality of accounts maintained by the respective borrower.

2. The method of claim 1 wherein receiving respective borrower accounting information includes importing the respective borrower accounting information directly from the accounting modules executed on the source computer systems.

3. The method of claim 1 wherein receiving respective borrower accounting information includes importing the respective borrower accounting information directly from data files without communicating with the accounting modules executed on the source computer systems.

4. The method of claim 1 wherein receiving respective borrower accounting information includes receiving respective normalized borrower accounting information for each of the borrower accounts from the source computer systems by the trusted third party evaluation system.

5. The method of claim 1 wherein determining an exclusion amount includes determining whether the invoice was sent by the respective borrower or received by the respective borrower.

6. The method of claim 1 wherein at least one of the invoices has a negative amount and is a credit memorandum, and further comprising:
subtracting the negative amount of the respective credit memorandum from the gross accounts receivable value.

7. The method of claim 1 wherein determining an exclusion amount includes, for each of a number of defined exclusions types:
determining whether at least one characteristic of the respective invoice meets one or more exclusion conditions of the respective exclusion type; and
setting the exclusion amount equal to an accounts receivable amount of the respective invoice if all of the at least one characteristic of the respective invoice meets the one or more exclusion conditions.

8. The method of claim 1 wherein determining an exclusion amount includes, for each of a number of exclusion criteria:
determining whether an accounts receivable for the respective invoice meets one or more exclusion conditions of the respective exclusion type; and
setting the exclusion amount equal to a lesser of: an accounts receivable amount of the respective invoice or a sum of contra account amounts, if all of the at least one characteristic of the respective invoice meets the one or more exclusion conditions.

9. The method of claim 1 wherein determining an eligible total accounts receivable value for the respective borrower account includes subtracting a number of lender exclusion amounts from an accounts receivable amount.

10. The method of claim 9 wherein determining an eligible total accounts receivable value for the respective borrower account includes multiplying an accounts receivable amount by a defined advance rate for the first lender.

11. The method of claim 10 wherein determining an eligible total accounts receivable value for the respective borrower account includes limiting the eligible total to a maximum accounts receivable amount specified by the first lender.

12. The method of claim 1 wherein determining an eligible total accounts receivable value for the respective borrower account includes multiplying an accounts receivable amount by a defined advance rate for the first lender.

13. The method of claim 1 wherein determining an eligible total accounts receivable value for the respective borrower account includes limiting the eligible total to a maximum accounts receivable amount specified by the first lender.

14. An evaluation system, comprising:
at least one nontransitory processor-readable medium that stores at least one of information or processor executable instructions;
at least one communications port; and
at least one processor communicatively coupled to the at least one nontransitory processor-readable medium and to the at least one communications port, and which:
receives parameters input via the at least one communications port from at least a first lender computer system controlled by a first lender, the parameters input specifying a number of parameters imposed by at least the first lender;
receives respective borrower accounting information including data and metadata for each of a number of borrowers via the at least one communications port from each of a number of accounting modules executed on a number of source computer systems which are distinct from the first lender computer system, the data and metadata representative of a plurality of invoices; and
for each of a plurality of borrower accounts maintained by the first lender and logically associated with a respective one of the borrowers:
for each of the plurality of accounts maintained by the respective one of the borrowers:
for each of the plurality of invoices issued to or received from the respective one of the accounts:
determines an age of the respective invoice based on a first piece of metadata and a reporting date,
determines if the determined age of the respective invoice exceeds a defined age limit,
adds a total amount of the respective invoice to an over aged invoice limit value if the determined age of the respective invoice exceeds the defined age limit,
adds the amount of the respective invoice to a gross accounts receivable value,
subtracting the amount of the respective credit memorandum from a gross accounts receivable value; and
for each of the plurality of customer accounts maintained by the respective one of the borrowers:
for each of the plurality of invoices for the accounts:
determines an exclusion amount, and
determines an eligible total accounts receivable value for the respective borrower account based at least in part on the determined exclusion amount.

15. The evaluation system of claim 14 wherein the respective borrower accounting information received via the at least one communications port is normalized borrower accounting information for each of the borrower accounts from the source computer systems.

16. The evaluation system of claim 14 wherein to determine an exclusion amount the at least one processor determines whether the invoice was sent by the respective borrower or received by the respective borrower.

17. The evaluation system of claim 14 wherein at least one of the invoices has a negative amount and is a credit memorandum, and the at least one processor further subtracts the absolute amount of the respective credit memorandum from the gross accounts receivable value.

18. The evaluation system of claim 14 wherein to determine an exclusion amount the at least one processor, for each of a number of defined exclusions types:
determines whether at least one characteristic of the respective invoice meets one or more exclusion conditions of the respective exclusion type; and
sets the exclusion amount equal to an accounts receivable amount of the respective invoice if all of the at least one characteristic of the respective invoice meets the one or more exclusion conditions.

19. The evaluation system of claim 14 wherein to determine an exclusion amount the at least one processor, for each of a number of exclusion criteria:
determines whether an accounts receivable for the respective invoice meets one or more exclusion conditions of the respective exclusion type; and
sets the exclusion amount equal to a lesser of: an accounts receivable amount of the respective invoice or a sum of contra account amounts, if all of the at least one characteristic of the respective invoice meets the one or more exclusion conditions.

20. The evaluation system of claim 14 wherein to determine an eligible total accounts receivable value for the respective borrower account the at least one processor subtracts a number of lender exclusion amounts from an accounts receivable amount.

21. The evaluation system of claim 20 wherein to determine an eligible total accounts receivable value for the respective borrower account the at least one processor further multiplies an accounts receivable amount by a defined advance rate for the first lender.

22. The evaluation system of claim 21 wherein to determine an eligible total accounts receivable value for the respective borrower account the at least one processor further limits the eligible total to a maximum accounts receivable amount specified by the first lender.

23. A method of operation of a system that includes at least one processor, at least one nontransitory processor-readable medium, and at least one communications port, the method comprising:
extracting accounts receivable information by the at least one processor from at least one accounting module for all of a plurality of outstanding invoices originated by a borrower including data and metadata, the data and metadata representative of respective sets of customer identity information, a respective invoice date and a respective invoice amount for each of the plurality of outstanding invoices originated by the borrower;
extracting accounts payable information by the at least one processor from at least one accounting module for all of a plurality of outstanding invoices received by the borrower including data and metadata, the data and metadata representative of respective sets of vendor identity information, a respective invoice date and a respective invoice amount for each of the plurality of outstanding invoices received by the borrower; and
transferring the extracted information to a trusted third party computer system via that at least one communications port.

24. The method of claim 21 wherein extracting accounts receivable information includes extracting the customer identity information in the form of a customer name, a customer address, a customer telephone number, a customer facsimile number or a customer uniform resource locator (URL).

25. The method of claim 23 wherein extracting accounts payable information includes extracting the vendor identity information in the form of a vendor name, a vendor address, a vendor telephone number, a vendor facsimile number, or a vendor uniform resource locator (URL).

26. The method of claim 23, further comprising:
extracting accounts receivable information by the at least one processor from at least one accounting module for all of a plurality of outstanding credit memorandums originated by the borrower including data and metadata, the data and metadata representative of respective sets of customer identity information, a respective credit memorandum date and a respective credit memorandum amount for each of the plurality of outstanding credit memorandums originated by the borrower.

27. The method of claim 23, further comprising:
unifying at least one of a number of customer entities and/or a number of vendor entities;
matching accounts receivable over a number of the outstanding invoices originated by the borrower to a number of the customer entities; and
matching accounts payable over a number of the outstanding invoices received by the borrower to a number of the vendor entities.

28. The method of claim 23 wherein extracting a set of accounting information includes directly importing the set of accounting information.

29. The method of claim 23 wherein extracting a set of accounting information includes extracting the set of accounting information via a number of application programming interface calls to the at least one accounting module.

30. An evaluation system, comprising:
at least one nontransitory processor-readable medium that stores at least one of information or processor executable instructions;
at least one communications port; and
at least one processor communicatively coupled to the at least one nontransitory processor-readable medium and to the at least one communications port, and which:
extracts accounts receivable information from at least one accounting module for all of a plurality of outstanding invoices originated by a borrower including data and metadata, the data and metadata representative of respective sets of customer identity information, a respective invoice date and a respective invoice amount for each of the plurality of outstanding invoices originated by the borrower;
extracts accounts payable information from at least one accounting module for all of a plurality of outstanding invoices received by the borrower including data and metadata, the data and metadata representative of respective sets of vendor identity information, a respective invoice date and a respective invoice amount for each of the plurality of outstanding invoices received by the borrower; and
transferring the extracted information to a trusted third party computer system via the at least one communications port.

31. The evaluation system of claim 30 wherein to extract accounts receivable information the at least one processor extracts the customer identity information in the form of a customer name, a customer address, a customer telephone number, and a customer facsimile number.

32. The evaluation system of claim 30 wherein to extract accounts payable information the at least one processor extracts the vendor identity information in the form of a vendor name, a vendor address, a vendor telephone number, and a vendor facsimile number.

33. The evaluation system of claim 30 wherein the at least one processor further:
extracts accounts receivable information from at least one accounting module for all of a plurality of outstanding credit memorandums originated by the borrower including data and metadata, the data and metadata representative of respective sets of customer identity information, a respective credit memorandum date and a respective credit memorandum amount for each of the plurality of outstanding credit memorandums originated by the borrower.

34. The evaluation system of claim 30 wherein the at least one processor further:
unifies at least one of a number of customer entities or a number of vendor entities;
matches accounts receivable over a number of the outstanding invoices originated by the borrower to a number of the customer entities; and
matches accounts payable over a number of the outstanding invoices received by the borrower to a number of the vendor entities.

35. The evaluation system of claim 30 wherein to extract the set of accounting information the at least one processor directly imports the set of accounting information.

36. The evaluation system of claim 30 wherein to extract the set of accounting information the at least one processor extracts the set of accounting information via a number of application programming interface calls to the at least one accounting module.
